(19) United States
(12) Patent Application Publication
(10) Pub. No.: US 2003/0086438 A1
(43) Pub. Date: May 8, 2003

(54) Method for accessing messages, and associated apparatuses and software programs

(76) Inventors: Josef Laumen, Hildesheim (DE); Markus Trauberg, Velchede (DE); Andreas Schmidt, Braunschweig (DE); Jerbi Belhassen, Muenchen (DE); Sabine Van Niekerk, Salzgitter (DE)

Correspondence Address: BELL, BOYD & LLOYD, LLC, P. O. BOX 1135, CHICAGO, IL, 60690-1135, US

(21) Appl. No.: 10/068,702

(22) Filed: Feb. 4, 2002

(30) Foreign Application Priority Data
Feb. 2, 2001 (DE) 101 04 713.4
Jun. 27, 2001 (EP) 01115495.2

(51) Int. Cl. H04J 3/02

(52) U.S. Cl. 370/462; 370/461

(57) ABSTRACT

A method, and associated apparatuses and software programs, which makes it possible to manipulate, for example to recall or to replace, a first message, preferably sent using a mobile radio system and/or the Internet, in particular a multimedia message, preferably of the MMS type, using a second message sent at a time after the first message. This increases the user friendliness for the users of such systems.

### BACKGROUND OF THE INVENTION

The present invention relates to a method for accessing a first message, in particular a multimedia message, preferably of the MMS type, with the first message being sent to a receiving application using a sending application or a VAS application.

The present invention also relates to appropriate telecommunication devices, network elements and software programs.

The mobile radio system GSM (GSM—Global System for Mobile Communications) affords not only voice telephony but also the opportunity to send and receive short text messages of up to 160 characters in length. This service is called SMS (SMS—Short Message Service), see GSM 03.40 version 7.4.0, Release 1998; Digital Cellular Telecommunications System; Technical Realization of the Short Message Service (SMS).

For the next generation of mobile radio systems UMTS (UMTS—Universal Mobile Telecommunication System), a variant of a mobile messaging service which has a multimedia capability is currently being standardized, the so-called MMS (MMS—Multimedia Messaging Service), see 3G TS 22.140 version 4.0.1, Release 2000; Third Generation Partnership Project; Technical Specification Group Services and System Aspects; Service Aspects; Stage 1; Multimedia Messaging Service (MMS). Messages with multimedia contents are simply abbreviated to MMs (MM—Multimedia Message; plural: MMs) below in instruction to distinguish them better from the text messages of the SMS. In contrast to the SMS, they are limited to pure text contents. With the MMS, it will be possible to format texts according to individual taste and to embed audio and video contents into a message. Another novelty is that, for the delivery of MMs, a known distinction is drawn between the “PUSH” mode (deliver mode), where an incoming MM is delivered to the recipient without delay, and the “PULL” mode (fetch mode), where the recipient is first informed about a recently received MM and can then personally decide when he/she downloads this MM to his/her terminal. These known relationships are shown in FIG. 1, where the reference 12 labels a network element referred to as MMS server and the reference 11 labels a UMTS terminal.

On the basis of the prior art to date, the MMS can be implemented only using WAP (WAP—Wireless Application Protocol). To bridge the air interface between a terminal with MMS capability and the WAP gateway, use of the WAP WSP (WSP—Wireless Session Protocol), see WAP-203-WSP, Version May 4, 2000; Wireless Application Protocol, Wireless Session Protocol Specification; Chapter 8.4: “Header Encoding”, is provided, see 3G TS 22.140 version 4.0.1 (see above); 3G TS 23.140 version 4.0.0, Release 4, Third Generation Partnership Project, Technical Specification Group Terminals, Multimedia Messaging Service (MMS), Functional Description, Stage 2.

FIG. 2 shows a “transaction flowchart” based on today's prior art in accordance with 3G TS 23.140 version 4.0.0 (see above), where the interchange of the WAP messages between the three authorities involved when sending and receiving an MM is shown; namely, a sending application UAA (UAA is the abbreviation for MMS User Agent A), network element RS (RS is the abbreviation for MMS Relay/Server) and a receiving application UAB (UAB is the abbreviation for MMS User Agent B). In this context, MMS User Agent is understood to be an application on a mobile radio or on a unit (e.g., laptop or the like) which implements the MMS and is connected to a mobile radio. An MMS Relay/Server is a network element in the area of competence or in the MMS environment of the MMS service provider providing the MMS functionality for the applications “MMS User Agents”.

The interchange of the WAP messages is described below with reference to the known transaction flowchart in FIG. 2 (“sending application UAA sends MM_{A} to receiving application UAB”). In this case, it is initially assumed, for simplicity, that the sending application UAA 1 and the receiving application UAB 12 use the MMS from the same MMS service provider. The MM_{A} produced in the sending application UAA 1 is sent with the WAP message M-Send.req to the network element RS 2, 12 (since this network element performs functions both at the sender end and at the recipient end, it is labeled with the dual reference symbol 2, 12). The transmitting application UAA 1 then receives the WAP message M-Send.conf back, the message being used by the network element RS 2, 12 to confirm correct receipt of the MM_{A}. It also contains an identification number ID1 for the MM_{A} sent, the identification number being stipulated by the network element RS 2, 12 and possibly being individual. The network element RS 2, 12 then uses the WAP message M-Notification.ind to inform the receiving application UAB 11 about the memory location (URI—Uniform Resource Identifier; the abbreviation URI is used below) of the MM_{A} which has recently been received and is available for download. The network element RS 2, 12 then receives, e.g. with the WAP message M-NotifyResp.req, confirmation that the notification about the MM_{A} received (M-Notification.ind) has been delivered successfully. At this moment, the network element RS 2, 12 has not yet allocated any Message-ID for the MM available for download. When interchanging the two WAP messages M-Notfication.ind and M-NotifyResp.req, only one transaction identity number (Transaction ID) specific to this notification is interchanged. The receiving application UAB then uses the WAP message WSP GET, with which the URI is sent to the network element RS 2, 12, to request delivery of the MM_{A}. The network element RS 2, 12 then uses the WAP message M-Retrieve.conf to deliver the desired MM_{A} to the receiving application UAB 11. In this context, the MM_{A} is identified using the, possibly individual, identification number ID2 allocated by the network element RS 2, 12. The WAP message M-Acknowledge.ind is used by the receiving application UAB 11 to acknowledge correct receipt of the MM_{A}. If the sender has expressed the desire to be notified about successful receipt of the MM_{A} which he/she has sent, the network element RS 2, 12 can comply with this by sending the WAP message M-Delivery.ind to the transmitting application UAA 1.

FIG. 3 shows a known MMS architecture option where the sending application UAA 1 and receiving application UAB 11 involved in interchanging an MM use the MMS of various MMS service providers (MMS service provider A and MMS service provider B). In this case, it is necessary to forward the MM between the MMSEs (MMSE—Multimedia Messaging Service Environment MMS environment) of the MMS service providers involved. The reference numeral 4 labels the MMSE of the MMS service provider A, and the reference numeral 14 labels the MMSE of the service provider B. An MM is forwarded between two MMSEs and, more precisely in this context, between the sender-end network element RSA 2 (RSA is the abbreviation for MMS Relay/Server A) and the reception-end network element RSB 12 (RSB is the abbreviation for MMS Relay/Server B), using SMTP (SMTP—Simple Mail Transfer Protocol), see 3G TS 23.140, version 4.0.0 (see above), e.g., over the Internet (IP—Internet Protocol with reference numeral 20). The SMTP protocol is denoted by the reference numeral 22 in FIG. 3. As is customary in general, the mobile radio network is referred to as a PLMN (PLMN—Public Land Mobile Network) in FIG. 3 and bears the reference numeral 6 in FIG. 3. During editing, each MM can be assigned a time at which the MM is to be delivered to the recipient, more precisely to the receiving application UAB 11, at the earliest. If use is made of this, provision is made for the MM to be buffer-stored in the sender-end MMSE_{A} 4 (more precisely, in a memory “MMS Server A” with the reference numeral 3), until this time is reached, see above, Report of the 3GPP TSG-T2 SWG3 MMS Ad Hoc Meeting #5 in Sophia Antipolis, France Oct. 10-12, 2000, T-doc: T2M00092; chapter 7; 3GPP TSG-T2 SWG3. Only after that is the MM transmitted to the reception-end MMSE_{B} 14. In addition, it is also possible to indicate a desired validity period when editing any MM. Storage of an MM until the validity expires or until the MM is downloaded, before that, by the receiving application UAB 11 will be effected in the reception-end MMSE_{B} 14 (more precisely, in a memory “MMS Server B” with reference numeral 13), see above, Report of the 3GPP TSG-T2 SWG3 MMS Ad Hoc Meeting #5.

As can be seen from the known MMS reference architecture shown in FIG. 3, the MMs can originate not only from applications UAA and UAB, but also from MMS VAS applications (VAS Value Added Services), which are labeled with the reference numeral 7 in FIG. 3. This is a network device providing supplementary services. In this case, the MM7 interface serves as communication interface between an MMS VAS application and a network element RS. To date, no mandatory MMS-specific messages have been defined for this interface. The communication in this case can be based on HTTP (Hypertext Transport Protocol) or SMTP (Simple Mail Transport Protocol). In addition, in accordance with the current state of standardization, it is possible to use MM1-like coding for this interface.

The methods and apparatuses mentioned in the introduction allow a message to be edited by the sender or instructioner so long as it is still in the sending application UAA. When the message has been sent, it is no longer possible to have any influence or access. This problem presents itself not only when sending messages by radio, but also when sending electronic mail (e-mails) over the Internet and other communications systems.

It is an object of the present invention to develop the method and apparatuses of the type mentioned in the introduction such that editing or influencing of messages which is more oriented to the needs of the sender/recipient is made possible.

### SUMMARY OF THE INVENTION

The stated object is achieved for the method of the type mentioned in the introduction by virtue of a second message containing a manipulation instruction for manipulating the first message being created, sent, received, forwarded and/or processed in instruction to prompt or to arrange manipulative access to the first message.

In addition, this object is achieved for an appropriate telecommunication device. This is understood to include, in particular, mobile radio telephones and communication units connected to the Internet, including computers. The inventive system for creating, sending, receiving and/or processing the second message includes (besides the hardware units, such as, in particular, control units and processor units) software solutions which are presented in more detail below and preferably produce modifications to WAP messages using altered and/or newly defined header fields or can process the latter.

In addition, this object is achieved for an appropriate network element. Within the context of the present invention, such network elements are part of a communication system and allow communication between a number of transmission and/or reception units; in particular, a number of mobile telephones and/or computers connected to the Internet. Such a communication system, including radio communication systems, is normally operated by service providers. The inventive system for receiving, processing and/or forwarding the second message includes not only the necessary hardware elements, such as control units and processor units, but also, in particular, software which is described in more detail below and preferably produces modifications to WAP messages using appropriately adjusted or newly defined header fields or can process the latter.

A message within the context of the present invention can be a conventional SMS, an MM with multimedia contents or any other electronic message. The present invention is described below using the MM, without this intending to constitute a restriction to this message type. The text below uses the abbreviation MM_{A} for the first message and the abbreviation MM_{B} for the second message.

The advantages of the present invention are, in particular, that it allows a first message to be manipulated, or recalled, and/or subsequently altered or updated after being sent. On the basis of the present invention, such manipulation is possible when sending messages by radio, using mobile radio systems, between mobile radio systems, in particular using an inter-operator IP backbone, between mobile radio networks and other communications systems, such as Internet E-mail and/or over the Internet.

In particular, the present invention makes it possible to manipulate a first message, such as a multimedia message based on the MMS type, sent by an instructioner to a receiving application in a reception unit via at least one network element using a sending application in a transmission unit, which manipulation involves a second message, which contains manipulative information, being sent by the transmission unit, after the first message has been sent, to at least one network element which prompts or arranges manipulative access to the first message.

The first message and the second message are sent to the receiving application via at least one sender-end network element associated with a service provider and at least one recipient-end network element associated with a service provider. In this context, the at least one sender-end network element and the at least one recipient-end network element may belong to the area of competence of a single service provider or may even be, in the simplest case, identical.

Cases in which the receiving application and the sending application are identical are also possible.

With particular preference, the manipulative access to the first message is effected on a sender-end network element, on a recipient-end network element and/or on the receiving application.

If the receiving application has not yet been informed about the manipulation instruction, the first message is preferably manipulated either in the area of competence of the sender-end service provider or, in that of the recipient-end service provider, preferably without notifying the receiving application about the manipulation. On the other hand, if the reception end has already been notified about the first message, but this first message has not yet been downloaded, the first message is preferably manipulated in the area of competence of the sender-end service provider without informing the receiving application, or the manipulation is effected in the area of competence of the recipient-end service provider, with the receiving application preferably being informed about the manipulation and the time of the manipulation.

The inventive manipulation is not limited to the two service features Recall and Replace. Instructions relating to subsequent forwarding, subsequent attachment of the second message to the first message, etc., are also understood by manipulation within the context of the present invention. The Recall and Replace instructions are described in more detail below.

In accordance with one embodiment of the present invention, it is possible to continue to “recall” (the term used in this disclosure) an MM at least until the recipient has moved it to another folder, forwarded it to another recipient or opened it.

In accordance with another embodiment of the present invention, an MM can advantageously continue to be changed (“replaced” is the term used in this disclosure) subsequently even if the recipient has already “touched” the MM. In this case, the recipient is informed about subsequent changing of the appropriate MM, preferably immediately, either by a notification so that he/she can subsequently initiate download of the updated MM himself/herself (PULL mode), or straight away by automatic delivery of the updated MM (PUSH mode).

In one embodiment of the present invention, it is also possible for the sender of an MM, i.e. sending application (MMS User Agent) or MMS VAS application, to recall a previously sent MM, or to alter or update it subsequently, by specifying certain conditions. These conditions, which can be chosen by the sender and are contained in information elements in the second message, may, in particular, be the following: recall an MM only if the recipient has not yet been informed about an MM available for download, or execute the Replace instruction even if the MM has already been delivered to the recipient's terminal, but it has not yet been opened. These service features are called “Conditional Recall” (or “Conditional Cancel”) or “Conditional Replace” below. The term “Change” or “Replace” is understood to mean replacement, in particular, but also any other form of change. In this context, the inventive information elements are, by way of example, appropriately extended or newly defined header fields in WAP messages.

An advantage of this inventive aspect is the provision of scalability and flexibility for the recall and/or replacement of a previously sent MM. These service features increase the attractiveness of the multimedia messaging service.

The sender of a message (MM), both within the context of unconditional and conditional manipulation instructions, may be a sending application “MMS User Agent” or an MMS VAS application. Such a sending application may, by way of example, be an application on a mobile terminal, while an MMS VAS application represents a network application providing value added services.

A further subject of the present invention is the implementation of the inventive method in WAP by modifying existing header fields or adding newly defined header fields to the relevant WAP messages in the WAP-MMSEncapsulation Standard, see WAP-209-MMSEncapsulation, Release 2000; Wireless Application Protocol; WAP Multimedia Messaging Service; Message Encapsulation; MMS Proposed SCD 1.0.

Similarly, the appropriate binary coding, as described further below for exemplary embodiments, is a subject of the present invention.

Additional features and advantages of the present invention are described in, and will be apparent from, the following Detailed Description of the Invention and the Figures.

### BRIEF DESCRIPTION OF THE FIGURES

FIG. 1 shows a comparison of the PULL and PUSH modes as per UMTS, based on the prior art.

FIG. 2 shows a transaction diagram for a multimedia messaging service (MMS) based on the prior art.

FIG. 3 shows a schematic illustration of a multimedia messaging service architecture based on the prior art.

FIG. 4 shows a multimedia messaging service allowing manipulation of a first message, based on the present invention.

FIG. 5 shows coding for newly defined header fields.

FIG. 6 shows additions to the known header field X-Mms-Status.

FIG. 7 shows newly introduced header field X-Mms-Original-Message-Status.

FIG. 8 shows newly introduced header field X-Mms-Original-Message-ID.

FIG. 9 shows coding for further newly defined header fields.

FIG. 10 shows additions to the header field X-Mms-Supported-Feature.

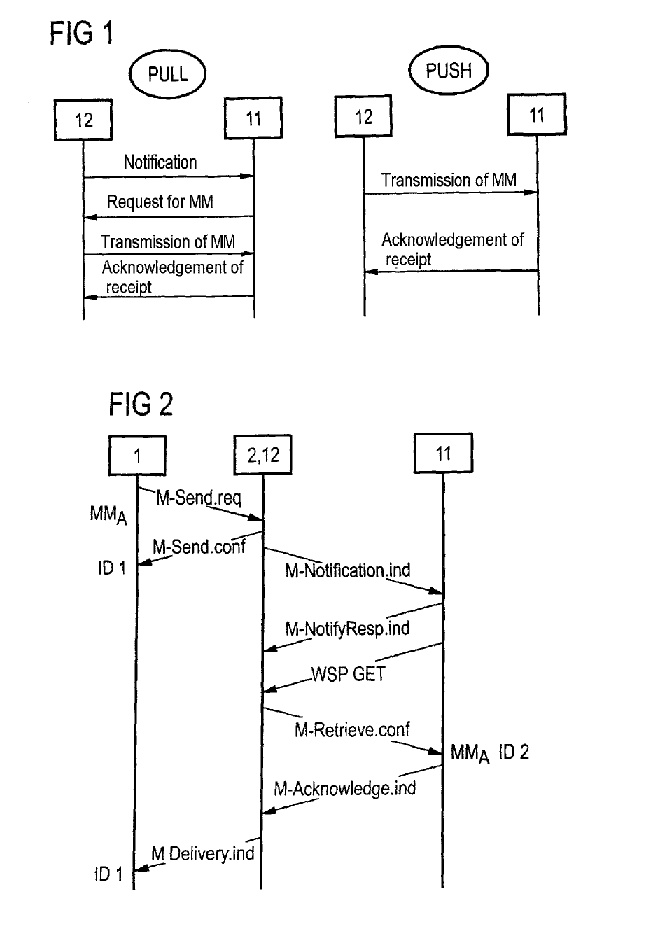

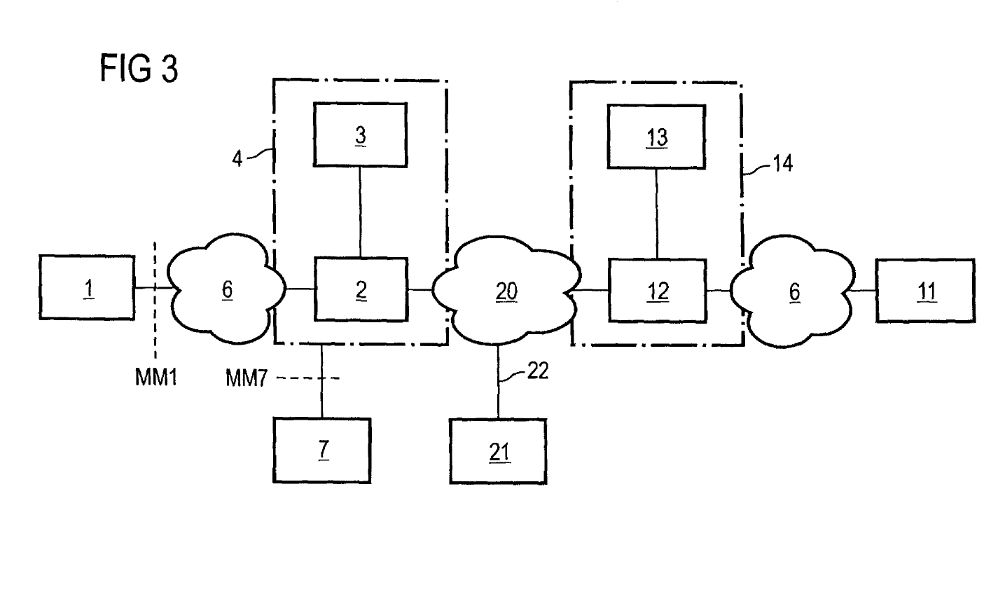

### DETAILED DESCRIPTION OF THE INVENTION

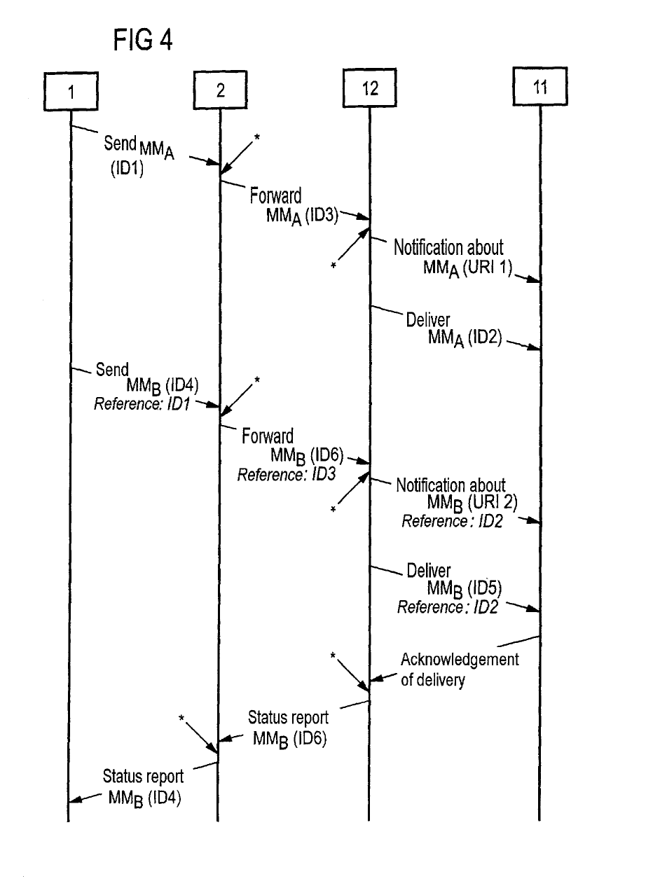

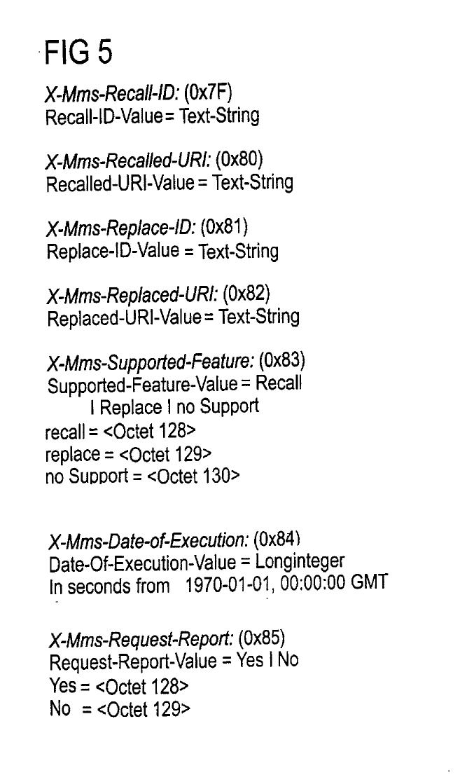

The description of the exemplary embodiments is based, with reference to the top third of FIG. 4, on the following known procedure for sending and receiving a first message MM_{A} through the mediation of a first and a second MMS service provider (service provider A and service provider B): after the first message MM_{A} has been sent, the sending application UAA 1 of the sender is notified of a Message-ID for the previously sent MM_{A} in the WAP message M-send.conf (ID1). This identification number ID is produced by the network element RSA 2 of the service provider A and clearly identifies the MM_{A} within the sender-end interface between sending application UAA 1 and network element RSA 2. When the MM_{A} is delivered at the recipient end from the network element RSB 12 of the service provider B to the receiving application UAB 11 by the WAP message M-Retrieve.conf, a Message-ID (ID2 in FIG. 2) is likewise transmitted. This identification number ID2 is possibly produced freshly by the network element RSB 12 and is used for clearly identifying the MM_{A} at the recipient end within the interface between network element RSB 12 and receiving application UAB 11.

For the purpose of sending the MM_{A} between the sender-end network element RSA 2 and the recipient-end network element RSB 12, ID1 can be converted into an interim identification number (ID3) identifying the MM_{A} between the various systems (note: in FIG. 4 the points marked by an asterisk generally refer to such conversions of the Message-IDs between the interfaces). In particular, ID3 should be globally unique. By way of example, ID3 contains information regarding the service provider A, the ID1 and the time of the ID conversion. To this end, the sender-end network element RSA 2 needs to have the information or the opportunity to reverse this conversion; e.g., for delivery reports. In instruction to use IDs which are clear internally, the recipient-end network element RSB 12 can convert ID3 into the aforementioned internal ID2, which identifies the MM_{A} for the receiving application UAB 11. To this end, the recipient-end network element RSB 12, in turn, needs to have the information or the opportunity to reverse this conversion; e.g., for delivery reports. The MM_{A} is identified at the recipient end by ID2.

On the basis of the present invention, the sending application, the receiving application and/or network elements mediating between the sending and receiving applications now provide the option of accessing the previously sent first message MM_{A} by providing a second message MM_{B}, which prompts or arranges manipulative access to the first message MM_{A}.

One option for identifying MM_{B} is explained below with reference to FIG. 4, where MM_{B} bears the identification number ID4. To transmit MM_{B} between the various service provider systems, ID4 can be converted by the sender-end network element RSA 2 into an interim ID (ID6) which identifies MM_{B} between the systems. In particular, ID6 should be globally unique; e.g., should contain a combination of information regarding the service provider A, ID4 and the time of conversion. To this end, the sender-end network element RSA 2 needs to have the information or the opportunity to reverse this conversion; e.g., for delivery reports. In instruction to use IDs which are clear internally, the recipient-end network element RSB 12 can convert ID6 into an internal ID (ID5) identifying MM_{B} for the receiving application UAB 11. To this end, the recipient-end network element RSB 12 needs to have the information or the opportunity to reverse this conversion; e.g., for delivery reports. MM_{B} is identified by ID5 at the recipient end.

To produce the necessary link between MM_{A} and MM_{B}, ID4 has a reference to ID1, ID6 has a reference to ID3, and ID5 has a reference to ID2. In addition, the notifications to the receiving application UAB 11 via MM_{A} and MM3 refer to two memory locations URI1 and URI2.

It is possible for the identification numbers ID1 and ID3, ID3 and ID2, and ID1, ID2 and ID3 to be identical. Similarly, ID4 and ID6, ID6 and ID5, and ID4, ID5 and ID6 may be identical.

At least one of the sender-end network elements involved and one of the recipient-end network elements involved is advantageously capable of carrying out one-to-one, reversible conversion of IDs and of managing the information relating thereto.

The manipulation options “Recall” and “Replace” are described by way of example below, with the latter term being understood within the context of the present invention to mean, by way of example, updating of the first message MM_{A}; in particular, by replacing the first message with the second message. Generally, however, all combinations of the options disclosed on the basis of the present invention can be provided for all types of manipulation; thus, for example, whether and using what information the recipient is notified about manipulation of a first message, whether information is to relate to the type of manipulation, whether the recipient is to be informed about the sender's wish to manipulate, whether the second message is to be delivered in PULL mode or in PUSH mode, whether the replacement is to be made on a sender-end network element or a recipient-end network element or on the receiving application UAB, whether the sender and/or the recipient is to be notified about the success of the manipulation, etc.

A. “Recall” Service Feature

On the basis of the present invention, a user of the MMS who has sent a first multimedia message MM_{A} and wishes to recall this MM_{A} already sent can send a new, second message MM_{B} containing the information that the previously sent, first message MM_{A} needs to be recalled again.

This preferably can be achieved by the present invention by virtue of the sender composing the new MM_{B}, which contains a Recall command but preferably no content (message body) intended for the recipient, and sending it to the same recipient as the MM_{A} sent previously. The recall identifier used is preferably the ID1 of the previously sent MM_{A}. The MM_{B} containing the recall information is first sent to the network element RSA of the sender. Here, a check is expediently carried out to determine whether the MM_{A} with the ID1 is still in the area of competence of the service provider A (MMSE_{A}) or whether it has already been forwarded to the MMSE_{B} of the service provider B. The former is the case, by way of example, if the time chosen by the sender for the desired delivery of his MM_{A} has not yet been reached. The latter is the case, by way of example, if the MM_{A} has not yet exceeded its validity period and has not yet been delivered to the receiving application UAB. As soon as the MM_{A} is found in an MMSE of the MMS service providers involved, deletion of MM_{A} and MM_{B} from the competent network element RS can be initiated.

If the receiving application UAB has already been informed about the MM_{A} available for it in the MMSE_{B} via of a notification, and the MM_{A} should still be in the area of competence/memory of the service provider B, then, on the basis of the present invention, a fresh notification can be used to make the receiving application UAB aware that the MM_{A} has been deleted by the service provider B and is therefore no longer available for download because the sender has recalled it. Furthermore, the present invention provides the MMS service provider B with the opportunity to transmit the date on which the Recall command was executed to the receiving application UAB.

Should the MM_{A} already have been delivered to the recipient, the aforementioned fresh notification can be used to make the recipient's receiving application UAB aware that the sender wishes to recall the MM_{A}. On the basis of the present invention, the MM_{A} can be deleted directly in the receiving application UAB, provided that this is supported by the Recall service feature. Depending on the implementation of this service feature in the terminal, on the user's settings, on the MMS service provider's settings and/or on the network operator's settings, the deletion of the MM_{A} in the terminal can be dependent on whether the MM_{A} has already been “touched” (e.g., opened, read, forwarded, etc.) by the recipient. However, it appears sensible to delete only those MMs after delivery which have not yet been “touched” by the recipient. The MM_{B} containing the recall information does not absolutely need to be delivered to the receiving application UAB; it can actually be deleted in the MMSE_{B}.

If the recipient (MMS User Agent B) of the MM_{A} has not yet received any notification about the MM_{A}, for example because the MM_{B} containing the recall information reaches the network element RSB before the MM_{A} to be recalled, he/she also need not be informed about a Recall action initiated by the sender. Instead, the network element RSB preferably waits until it receives the MM_{A} referring to the recall, and deletes it upon receipt without notifying the recipient (provided that the network element RSB supports the Recall service feature). Alternatively, MM_{A} also can be deleted actually on the network element RSA.

On the basis of the present invention, the Recall instructor (MMS User Agent A) is preferably informed about the outcome and the date of execution of the action he/she has initiated, if the MMS service providers involved allow this.

To be able to implement the Recall service feature just described, the present invention proposes that one or more of the following items of information additionally be interchanged between the authorities involved (sending application UAA, network element RSA, network element RSB and receiving application UAB):

Sending application UAA (MMS User Agent A)→network element RSA (MMS Relay/Server A) (when sending an MM):

Flag indicating that an MM_{B} is a Recall command.

Identification number of the MM_{A} needing to be recalled.

Information that the sender is requesting feedback about the outcome of the Recall action he/she has initiated.

Network element RSA (MMS Relay/Server A)→sending application UAA (MMS User Agent A) (upon confirmation after an MM has been sent):

Notification by the service provider of whether he/she supports the Recall service feature.

Network element RSA (MMS Relay/Server A)→network element RSB (MMS Relay/Server B) (only necessary if sender and recipient belong to different MMSEs):

Flag indicating that an MM_{B} is a Recall command.

Identification number of the MM_{A} needing to be recalled.

Information that the sender is requesting feedback about the outcome of the Recall action he/she has initiated.

Transmission of the information between network element RSA and network element RSB is dependent on whether this information was available when the MM_{B} was sent.

Network element RSB (MMS Relay/Server B)→receiving application UAB (MMS User Agent B) (upon notification about an MM received), preferably in a message:

Information regarding when the recall was executed.

Information that an MM_{A}, previously announced by a notification, is now no longer available for download. MM_{A} which has been deleted in the MMSE_{B} is identified using the message reference (URI). or:

Information that an MM_{A} already delivered is being recalled by the sender. The MM_{A} being recalled is identified on the receiving application UAB using the Message-ID.

Receiving application UAB (MMS User Agent B)→network element RSB (MMS Relay/Server B) (after notification):

Information regarding whether the recipient has understood that an MM_{A} previously announced by a notification is now no longer available for download. or:

Information regarding whether the receiving application UAB was able to execute or prompted recall (i.e., deletion) of the MM_{A} successfully.

Information regarding whether the recipient has been informed (and/or has agreed to the recall) that an already downloaded MM_{A} has been recalled and is therefore no longer available in the memory, to which the receiving application UAB has access, in the terminal (or in connected equipment/memory cards).

Network element RSB (MMS Relay/Server B)→network element RSA (MMS Relay/Server A) (only necessary if sender and recipient belong to different MMSEs and if the sender has requested feedback):

Information regarding whether the Recall instruction was able to be executed successfully.

Information regarding when the Recall instruction was executed.

Information regarding whether the Recall instruction has been executed automatically.

Information regarding whether the recipient has been informed about the recall (and/or has agreed to the recall).

Information that an already downloaded MM_{A} has been recalled and is therefore no longer available in the memory, to which the receiving application UAB has access, in the terminal (or in connected equipment/memory cards).

Identification number of the MM_{A} which has been recalled.

Network element RSA (MMS Relay/Server A)→receiving application UAA (MMS User Agent A) (in a report):

Information regarding whether the Recall instruction was able to be executed successfully.

Information regarding when the Recall instruction was executed.

Information regarding whether the Recall instruction has been executed automatically.

Information regarding whether the recipient has been informed about the recall (and/or has agreed to the recall).

Information that an already downloaded MM_{A} has been recalled and is therefore no longer available in the memory, to which the receiving application UAB has access, in the terminal (or in connected equipment/memory cards).

Identification number of the MM_{A} which has been recalled.

Additional Service Feature: Conditional Recall

This special aspect of the present invention is based on the idea of conditionally recalling (“Conditional Recall/Cancel”) and conditionally changing/replacing or updating multimedia messages (“Conditional Replace”). According to the present invention, the execution of a Recall or Replace instruction subsequently sent by the sender of an MM is linked to particular conditions. By way of example, the sender may wish to recall or update a particular MM only if the recipient has not yet been informed about receipt. In other cases, he/she may wish to delete or replace it even if the receiving application UAB has received a notification or even if the MM has been read. In addition, a concept for implementing these service features is part of the present invention, where it is necessary to introduce or adjust data fields from the 3GPP MMS specification, see above, 3G TS 23.140 version 4.0.0. In this case, new header fields for the WAP messages are defined and other fields are adjusted or extended.

On the basis of this preferred embodiment of the present invention, it is possible to send a second message, called MM_{B} below, containing the information that the first message, i.e. MM_{A}, needs to be cancelled or recalled under certain conditions. The new MM_{B} contains information for executing the action of recalling the MM_{A}. According to the present invention, the sender of the Recall command sets conditions for carrying out his/her request. In this case, the sending User Agent or the VAS application stipulates in what case the previously sent MM needs to be deleted or cancelled.

According to the present invention, the service provider can limit the use of the recall feature to his/her own domains or to certain domains of other service providers. This can be done using an identification for the address of the recipient, for example his/her call number, E-mail address or the like. Another option would be to use an additional flag in the Recall command.

The conditional recall is then based on the editing phase or the editing status of the previously sent message; in particular, an MM. In this case, the sender decides in what status of the MM it needs to be deleted. Possible conditions stipulated by the sender for recall may be, in particular, as follows:

1. Recall the MM only if the MM is still on the server and the recipient has not yet been made aware of this. In this case, recall is thus effected only if no notification has been sent yet.

2. Recall the MM even if the notification has been sent, but the MM has not yet been downloaded.

3. Recall the MM if the recipient has not yet opened it or read it. In this case, recall can also be effected after download.

4. Recall the MM irrespective of the degree of editing of the MM with the recipient. In this case, a recall attempt is made even if the recipient has read the MM.

For implementing this service feature, a standard condition “default value” is advantageously adopted. By way of example, it may be agreed that a standard condition corresponds to one of the four cases described above. This default can, by way of example, be stipulated, so long as nothing explicit has been expressed regarding the conditional execution of the Recall command, such that the recall needs to be effected, by way of example, only before a notification about the presence of an MM. The system could also be designed such that a recall needs to be effected only before the MM to be deleted has been downloaded or even after the MM has been opened or read.

The text below deals with the transactions for implementing the MM-status-dependent recall feature. An MM_{A} already sent thus can be recalled again subsequently by the sender by virtue of his/her composing a new MM_{B} which contains a Conditional Recall command, but preferably no content (message body) intended for the recipient. This new message is sent to the same recipient as the MM_{A} sent previously. The recall identifier used is preferably the identification number (ID 1) of the previously sent MM_{A}. The MM_{B} containing the Recall information is first sent to the network element RSA (MMS Relay/Server A) of the sender. Here, a check is carried out to determine whether the MM_{A} with the ID 1 is still in the area of competence of the service provider A (Multimedia Messaging Service Environment A, MMSE_{A}) or whether it has already been forwarded to the MMSE_{B} of the service provider B. The former is the case, for example, if the time chosen by the sender for the desired delivery of his MM_{A} has not yet been reached. The latter is the case, for example, if the MM_{A} has not yet exceeded its validity period and has not yet been delivered to the receiving application UAB.

As soon as the MM_{A} is found in an MMSE, deletion of MM_{A} and MM_{B} from the competent network element RS can be initiated. If the original recipient has forwarded the MM_{A} sent to him/her to another address, the Recall command will preferably also be forwarded by the network element RSB as appropriate, wherein the recall can be effected in the destination-end network element RS. If the network element RSB has only the information that the MM has been forwarded, without knowing the destination (for example, if the original recipient has forwarded the MM sent to him to an e-mail address), the sender of the Recall command advantageously can be informed about the failure of the recall on account of forwarding. For reasons of confidentiality, it also would be possible to announce the failure of the operation without commenting on the reason in this case.

A particularly beneficial case for executing the Recall command is when the MM is still on one of the network elements RSA or RSB, and the receiving application UAB has not yet been notified about this message. Such a case could arise, for example, if the MM, at the request of the sender, is to be delivered at a particular time which has not yet actually occurred. In this case, the MM is still on the network element RSA of the sender. The MM may also have been stored on the network element RSB; for example, if the recipient's terminal is switched off and the validity period of the MM has not been exceeded. In these two cases, the MM can be deleted irrespective of the selected deletion conditions. This is because all four of the recall conditions described above cover this situation.

If the receiving application UAB has already been informed about the MM_{A} available for it in the MMSE_{B} via a notification, and the MM_{A} should still be in the area of competence/memory of the service provider B, then, on the basis of the present invention, recall can be executed only in the cases numbered 2, 3 and 4 above. For Conditional Recall case 1, the sender preferably receives a notification containing the declaration that the recipient has already been informed about the previously sent MM and the recall could not be executed. For the other cases (2, 3 and 4), a fresh notification can be used to make the receiving application UAB aware that the MM_{A} has been deleted by the service provider B and is thus no longer available for download because the sender has recalled it. Another option would be to inform the recipient about the recall action and to notify him/her that the MM is no longer available, or that it has been recalled, only when he/she requests said MM.

Should the MM_{A} already have been delivered to the recipient, recall can he effected only for case 4 (Recall irrespective of the degree of editing) and, under some circumstances, for case 3 (Recall if MM has not yet been opened/read). Preferably, a new notification is used to make the receiving application UAB aware, only for cases 3 and 4, that the sender wishes to recall the MM_{A}. This notification preferably contains the conditions for deletion.

The MM_{A} can therefore be deleted directly in the receiving application UAB, provided that this is supported by the recall feature. If case 3 is involved, the MM is deleted only if the terminal establishes that the MM has not yet been opened or read. For case 4, deletion is prompted irrespective of this. In both cases, the MM_{B} does not need to be delivered to the receiving application UAB. It can actually be deleted in the MMSE_{B}, since the notification is the trigger for deletion. For cases 1 (recall before the notification) and 2 (recall only before download), recall cannot be effected. In this context, the sender preferably receives feedback containing the information that the MM could not be recalled, since a notification has already been sent (case 1) or because the MM has already been downloaded (case 2).

According to the present invention, another option for implementing the deletion action is to deliver the MM_{B} containing the Recall information as far as the receiving application UAB. Deletion is then triggered in the recipient's terminal by the MM_{B} and not by the notification coming from the MM_{B}. This case is not handled in more detail below.

The instructor Recall (sending application UAA or VAS application) is preferably informed in all the cases described about the outcome and possibly the date of execution of the action he/she has initiated; in particular, if he/she requests this and also the MMS service providers involved allow this.

To be able to implement the “Conditional Recall” service feature just described, the present invention proposes that one or more of the following items of information additionally be interchanged between the authorities involved (sending application UAA, MMS network element RSA, MMS network element RSB and receiving application UAB). The bases taken are the current 3GPP specifications 3G TS 22.140 version 4.0.1 (see above), 3G TS 23.140 version 4.0.0 (see above), WAP specifications WAP-209-MMSEncapsulation, Release 2000 (see above), WAP-203-WSP, version May 4, 2000 (see above) and Report of the 3GPP TSG-T2 SWG3 MMS Ad Hoc Meeting #5 (see above). The text below gives a more detailed explanation of the differences and additions as compared with the Unconditional Recall operation:

Sending application UAA (MMS User Agent A)→network element RSA (MMS Relay/Server A) (when sending an MM):

Conditions for execution of the Recall operation:

Recall only before notification.

Recall only before download, and also after a notification has been sent.

Recall only if the MM has not been opened/read.

Recall irrespective of the degree of editing of the MM (even after the MM_{A} has been read).

Network element RSA (MMS Relay/Server A)→sending application UAA (MMS User Agent A) (upon confirmation after an MM has been sent):

Notification by the service provider of whether he/she supports the Conditional Recall feature. In this case, the system could draw a distinction between support for “Recall” and “Conditional Recall”.

Network element RSA (MMS Relay/Server A)→network element RSB (MMS Relay/Server B) (only necessary if sender and recipient belong to different MMSEs):

Conditions for executing the Recall operation:

Recall only before notification.

Recall only before download, and also after a notification has been sent.

Recall only if the MM has not been read.

Recall irrespective of the degree of editing of the MM (even after reading).

Network element RSB (MMS Relay/Server B)→receiving application UAB (MMS User Agent B) (upon notification about the MM_{B} received):

Conditions for executing the Recall operation:

Recall only before download, and also after a notification has been sent. This condition is communicated only if the MM has not been downloaded.

Recall only if the MM has not been read.

Recall irrespective of the degree of editing of the MM (even after reading).

Receiving application UAB (MMS User Agent B)→network element RSB (MMS Relay/Server B) (after notification):

Information regarding whether the conditional Recall instruction was able to be executed successfully.

In the event of failure, appropriate announcement, possibly giving reasons.

Network element RSB (MMS Relay/Server B)→network element RSA (MMS Relay/Server A) (only necessary if sender and recipient belong to different MMSEs and if the sender has requested feedback):

Information regarding whether the conditional Recall instruction was able to be executed successfully.

In the event of failure, appropriate announcement, possibly giving reasons.

Network element RSA (MMS Relay/Server A)→sending application UAA (MMS User Agent A) (for the report):

Information regarding whether the conditional Recall instruction was able to be executed successfully.

In the event of failure, appropriate announcement, possibly giving reasons.

Adjustments to the WAP Messages

The text below gives a more detailed explanation of possible modifications to the WAP messages for the “Recall” service feature. It should be stated first that, in the WAP specifications, the MMS User Agent corresponds to the MMS Client, and the MMS Proxy/Relay is referred to instead of the MMS Relay/Server, see WAP-203-WSP, Version May 4, 2000 (see above). When the present case refers to MMS User Agent, this is also intended to cover the MMS Client. The same is true of the terms MMS Relay/Server and MMS Proxy/Relay. For the sake of clarity, only the terms MMS User Agent and MMS Relay/Server are used below.

To add the “Recall” service feature to the WAP implementation of MMS, the present invention proposes modifying the WAP messages M-Send.req, M-Send.conf, M-Notification.ind, M-NotifyResp.ind and M-Delivery.ind. On the basis of the present invention, various header fields in these are extended or modified. On the basis of WAP-203-WSP (see above), each header field includes a coded field name and a coded field value. In this context, there are a total of four options for coding the field value, with the first octet of the field value determining the type and length of the coding (see Table 1).

A.1. WAP Message M-Send.req (from Sending Application UAA to the Network Element RSA)

The sender of an MM_{A} needs to express that he/she wishes to recall his/her MM_{A}. This is done by sending another MM_{B} to the same recipient. For this purpose, a header field in the WAP message M-Send.req used to send the MM_{B} can be extended, the header field bearing the identification number of that MM which the sender wishes to recall (ID1 of MM_{A} from FIG. 2). It is proposed that this header field have the name X-Mms-Recall-ID and the hexadecimal coding 0x7F (decimal: 127). Message-IDs are coded in conformity with the encapsulation standard (WAP-209-MMSEncapsulation, Release 2000; Wireless Application Protocol; WAP Multimedia Messaging Service; Message Encapsulation; MMS Proposed SCD 1.0), preferably in the form of a “text string”. In addition, the sender of an MM containing a Recall instruction preferably can be provided with the option of requesting feedback. To this end, it is proposed that a header field expediently named X-Mms-Request-Report and having the hexadecimal coding 0x85 (decimal: 133) be introduced into the WAP message M-Send.req. The field values of this header field are preferably coded in conformity with the encapsulation standard (see above) using the <Octet128> for “Feedback is required” and <Octet129> for “Feedback is not required”.

It is also proposed that, for the case of a Conditional Recall, a new header field additionally be added which conveys these conditions for executing the Recall command. For this, a header field having the exemplary name X-Mms-Recall-Cond and preferably having the hexadecimal coding 0x86 (decimal: 134) is proposed. This header field is preferably coded using the <Octet128> for Recall only before notification, using the <Octet129> for Recall only before download, even after a notification has been sent, using the <Octet130> for Recall if the MM has not been read (Recall only before reading) and using the <Octet131> for Recall irrespective of the degree of editing of the MM, even after reading. When other conditions are introduced, appropriate field values preferably need to be added. As an alternative to introducing the <Octet131>, it is also possible to agree that a Recall command without a header field X-Mms-Recall-Cond represent “Recall even after reading”.

A.2 WAP Message M-Send.conf (from the Network Element RSA to the Sending Application UAA)

On the basis of the present invention, this WAP message can be used for additionally notifying the sending application UAA of whether the service provider A has accepted the Recall instruction from the sender (MMS User Agent A). To this end, it is advantageously proposed that a new header field having the name X-Mms-Supported-Feature and the hexadecimal coding 0x83 (decimal: 131) be inserted into the WAP message M-Send.conf. Preferably, the field values used in conformity with the encapsulation standard (see above) are the <Octet128> for acknowledgement of an instruction and the <Octet130> for negative feedback (cf. FIG. 10).

Furthermore, on the basis of the present invention, the sending application UAA can additionally be notified of whether the service provider A supports conditional recall. For this purpose, it is proposed here that the field values of the X-MMS-Supported-Feature having the hexadecimal coding 0x83 (decimal: 131) have the value <Octet131> added to them, for example. In this context, this value represents support for conditional recall. If the MM_{A} is still stored on the network element RSA, and the receiving application UAB has not yet been notified, the MM is preferably deleted and the sending application UAA is preferably informed about this operation. For this purpose, the present invention proposes that the header field X-Mms-Status be added to the WAP message M-Send.conf. In this case, the new field value <Octet138> is preferably defined for “Recall successful, before notification”. In addition, it is proposed here that the new field value <Octet142> be stipulated for “Recall failed, since notification has been sent”. This coded value informs the sending application UAA which wanted to have case 1 of the Conditional Recall (Recall only before notification) executed that the MM_{A} was not able to be deleted if the notification had already been sent. This case may arise when the sending application UAA and the receiving application UAB are associated with the same network element RS, that is to say the network element RSA in this case.

A.3 WAP Message M-Notification.ind (from the Network Element RSB to the Receiving Application UAB)

If the receiving application UAB has already been informed about an MM_{A} available for download, then, on the basis of the present invention, a newly defined header field expediently named X-Mms-Recalled-URI and having the hexadecimal coding 0x80 (decimal: 128) can be used in the WAP message M-Notification.ind. This header field can be used to notify the receiving application UAB that the MM_{A} containing the specified URI is no longer available for download because it has been recalled by the sender. The field value of this newly defined header field is preferably coded as a text string in conformity with the encapsulation standard (see above).

To be able to inform the receiving application UAB about the time of deletion, a newly defined header field expediently named X-Mms-Date-Of-Execution and having the hexadecimal coding 0x84 (decimal: 132) can be extended, in accordance with the present invention. The field values for this header field are preferably coded in the form of a long integer in accordance with the encapsulation standard (see above).

On the basis of the present invention, the URI of the notification can refer to the memory location for a standard text message (e.g.: “This MM has been deleted again by the sender.”) which the network element RSB also can use to inform a receiving application UAB about a Recall instruction which has been executed, if the network element RSB does not support the Recall service feature (that is to say, does not recognize the new header fields) and attempts to download an MM from the memory location identified in the notification.

If the MM_{A} needing to be recalled has already been delivered to the receiving application UAB, then, on the basis of the present invention, the WAP message M-Notification.ind can contain the header field having the name X-Mms-Recall-ID defined in section A.1. The receiving application UAB can then immediately start deleting the MM_{A} using the Message-ID (ID2 from FIG. 2) (provided that it supports the Recall service feature).

If the MM_{A} to be deleted has been downloaded by the receiving application UAB, then, in the case of conditional recall, the receiving application UAB is preferably informed about the conditions for deleting the MM_{A}. For this purpose, the header field X-Mms-Recall-Cond which has been newly defined in accordance with the present invention and has the hexadecimal coding 0x86 (decimal: 134) is preferably used. In this case, only the coded values <Octet130> for Recall if the MM has not been read (“Recall before reading”) and <Octet131> for Recall irrespective of the degree of editing of the MM (“Recall even after reading”) are required. <Octet128> for Recall only before notification and <Octet129> for Recall only before download, even after a notification has been sent, are not required in this case, since, in this example, the MM_{A} should in both cases be deleted before the notification is sent.

A.4 WAP Message M-NotifyResp.req (from Receiving Application UAB to the Network Element RSB)

The present invention advantageously proposes optionally inserting a new header field in the WAP message M-NotifyResp.req, which new header field can be used to notify the network element RSB of whether the receiving application UAB has understood the announcement about a successfully executed Recall instruction. For this purpose, the header field X-Mms-Status known from other WAP messages is advantageously used and a new field value is defined: it is proposed that the <Octet136> have the meaning “Recall feature supported”.

If the MM_{A} to be recalled had already been delivered to the receiving application UAB, one advantageous variant of the present invention proposes inserting the header field X-Mms-Status defined in the encapsulation standard (see above) into the WAP message M-NotifyResp.req, which header field can be used to notify the network element RS of whether or not the Recall instruction from the sender was able to be executed successfully on the receiving application UAB. However, this requires this header field to be extended in this case too: the recall is preferably effected using the two new field values <Octet132> for “Recall instruction has been executed successfully” and <Octet133> for “Recall instruction could not be executed”.

For the case of conditional recall, in addition to the field values <Octet132> for “Recall successful” and <Octet133> for “Recall failed”, and to the field values proposed above <Octet138> for “Recall successful, before notification” and <Octet142> for “Recall failed, since notification has been sent” (see A.2), the following field values are proposed:

<Octet140> for “Recall successful, before MM has been read”

<Octet141> for “Recall successful, after MM has been read”

<Octet144> for “Recall failed, since MM has been read”

<Octet145> for “Recall failed, since MM has been deleted”.

These notifications mean that the sender of the Recall command can then be informed about the exact outcome of his/her instruction.

A.5 WAP Message M-Delivery.ind (from the Network Element RSA to the Sending Application UAA)

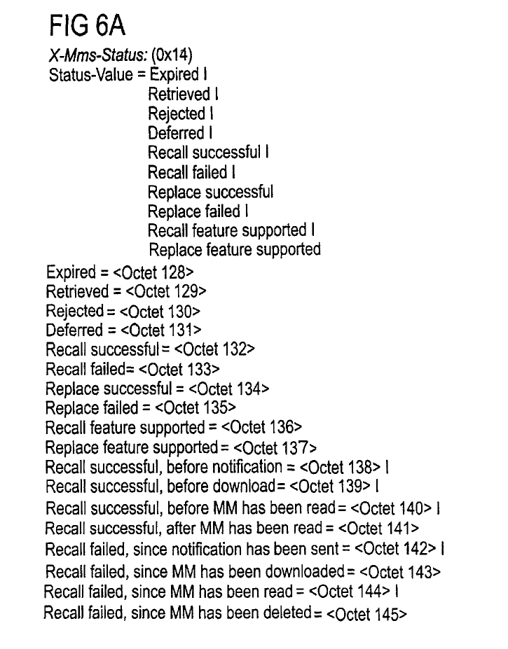

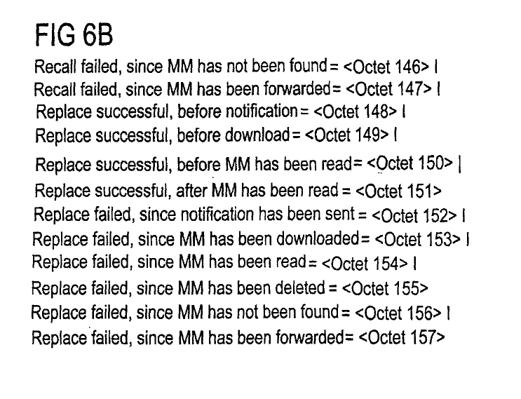

It is also proposed that the header field X-Mms-Status extended in section A.4 preferably also be inserted at this point. It can be used to notify the sender (sending application UAA) of whether or not his/her Recall instruction was able to be executed successfully, if, in this case too, the new field values <Octet132> for “Recall instruction has been executed successfully” and <Octet133> for “Recall instruction was not able to be executed” are used (cf. FIG. 6). In addition, the sender can be informed about the date of execution of his/her Recall instruction using the header field expediently named X-Mms-Date-Of-Execution defined in section A.3.

In addition, other new field values are preferably defined:

<Octet139> for “Recall successful, before download”

<Octet143> for “Recall failed, since MM has already been downloaded”

Hence, the various field values of the header field X-Mms-Status within the WAP message M-Delivery.ind make it possible to notify the sender of whether and under what circumstances his/her Recall instruction has been executed.

Another opportunity to inform the sender of a Conditional Recall command about execution of the instruction can be provided, on the basis of the present invention, by defining a new header field which is used for the appropriate WAP messages. To this end, a header field having the exemplary name X-Mms-Recall-Status is proposed. This header field can be used, in the cases described above, as a replacement for the extended header field X-Mms-Status. The latter can then continue to be used in the form defined in WAP-209-MMSEncapsulation, Release 2000 (see above). The new header field X-Mms-Recall-Status preferably contains only information regarding execution of the Recall instruction. For the X-Mms-Recall-Status, the hexadecimal coding 0x88 (decimal: 136) is proposed. The possible field values covering the various execution scenarios are, by way of example:

<Octet128> for “Recall successful”

<Octet129> for “Recall successful, before notification”

<Octet130> for “Recall successful, before download”

<Octet131> for “Recall successful, before MM has been read”

<Octet132> for “Recall successful, after MM has been read”

<Octet133> for “Recall failed”

<Octet134> for “Recall failed, since notification has been sent”

<Octet135> for “Recall failed, since MM has been downloaded”

<Octet136> for “Recall failed, since MM has been read”

<Octet137> for “Recall failed, since message has been deleted”

<Octet138> for “Recall failed, message not found”

<Octet139> for “Recall failed, message forwarded”.

For other reasons or conditions, the field values and codings can be extended as appropriate.

B. “Replace” Service Feature

A user of the MMS who has sent a multimedia message MM_{A} and later wishes to alter this MM already sent, can, on the basis of the present invention, send a new MM_{B} together with the information that this MM_{B} is intended to change, in particular replace, a previously sent MM_{A}. The statements below apply in a quite general sense to changes to a first message MM_{A}, and hence also, by way of example, to the subsequent attachment of a file to a previously sent MM_{A}.

MM_{A} can be replaced by virtue of the sender composing a new MM_{B}, which contains a Replace command, and sending it to the same recipient as the previously sent MM_{A}. To identify the MM_{A}, the ID1 of the previously sent MM_{A} which is now to be altered is advantageously used. The MM_{B} containing the Replace information is first sent to the network element RSA. There, a check is carried out to determine whether the MM_{A} with the ID1 is still in the area of competence (MMSE_{A}) of the service provider A, or whether it is already in the MMSE_{B} of the service provider B. Both are possible, according to whether the sender of the MM_{A} has indicated a time for the earliest possible delivery or a validity period. As soon as the MM_{A} has been found in an MMSE of the MMS service providers involved, replacement of the MM_{A} with the MM_{B} can be started by the competent network element RS. In practice, this action is preferably executed by deleting the old MM_{A} and forwarding the new MM_{B} to the recipient. On the basis of the present invention, the MMS service provider has the opportunity to make the receiving application UAB aware of a Replace action which may have been executed and/or of the date on which the Replace action was executed (“this MM was updated on . . . ”).

If the recipient (receiving application UAB) of the MM_{A} has not yet received any notification about the MM_{A}, for example because the MM_{B} containing the Replace instruction reaches the network element RSB before the MM_{A} which is to be replaced, it is not absolutely necessary for the recipient to be informed about a Replace action started by the sender. Instead, the network element RSB can wait until it receives the MM_{A} to be replaced, and changes, in particular replaces, it with the MM_{B} on arrival (provided that the MMS network element RSB supports the Recall service feature). On the basis of the present invention, the MMS service provider can make the receiving application UAB aware, when the MM_{B} is delivered, that the MM_{B} is an MM subsequently changed by the sender, and when this change was made.

If the receiving application UAB has already been informed about the MM_{A} available for it in the MMSE_{B} via a notification, and the MM_{A} should still be in the area of competence of the service provider B, then, on the basis of the present invention, a fresh notification can be used to make the receiving application UAB aware that the sender has changed his MM_{A} subsequently, and when this change was made.

Should the MM_{A} already have been delivered to the recipient, then either the receiving application UAB can first receive notification from the service provider B that there is an MM_{B} to replace the MM_{A}, or the MM_{B} containing the Replace instruction can be delivered to the receiving application UAB directly. Irrespective of whether the MM_{B} has been delivered in PUSH mode or in PULL mode, the MM_{A} can be changed, in particular replaced, with the MM_{B} directly in the receiving application UAB, provided that this is supported by the Replace service feature. Depending on the implementation of this service feature in the terminal, on the user's settings, on the service provider's settings and/or on the network operator's settings, MM_{A} can be changed, in particular replaced (and hence, in the case of the PULL mode: MM_{B} can additionally be requested) in the terminal on the basis of whether the MM_{A} has already been “touched” (e.g., opened, read, forwarded, etc.) by the recipient. It appears sensible for, in particular, those MMs which have not yet been “touched” by the recipient to be replaced automatically (i.e., without asking the recipient). If the recipient has already taken, forwarded or read the MM_{A} from the mail inbox, he/she can at least still be informed that the sender intended to replace the previously sent MM_{A} with MM_{B}.

On the basis of one advantageous variant of the present invention, the sender/instructioner (sending application UAA or VAS application) can be informed about the outcome and the date of execution of the Replace action he/she has initiated, if the MMS service providers involved support this.

MM_{A} can be identified on the receiving application UAB using, in particular, a message reference which is preferably a URI at whose memory location a standard text message from the recipient-end service provider B is stored. The URI is preferably made up of the identification number ID1 of MM_{A}, or of second identification numbers (ID2) stipulated by a recipient-end network element (in particular by the network element RSB).

To be able to implement the Change, in particular Replace, service feature just described, the present invention proposes that one or more of the following information items additionally be interchanged between the authorities involved (sending application UAA, network element RSA, network element RSB and receiving application UAB):

Sending application UAA (MMS User Agent A)→network element RSA (MMS Relay/Server A) (when sending an MM):

Flag indicating that an MM_{B} is a Replace command.

Identification number of the MM_{A} needing to be replaced.

Information that the sender is requesting feedback about the outcome of the Replace action he has initiated.

Network element RSA (MMS Relay/Server A)→sending application UAA (MMS User Agent A) (upon confirmation after an MM has been sent):

Notification by the service provider of whether he/she supports the Replace service feature.

Network element RSA (MMS Relay/Server A)→network element RSB (MMS Relay/Server B) (only necessary if sender and recipient belong to different MMSEs):

Flag indicating that an MM_{B} is a Replace command.

Identification number of the MM_{A} needing to be replaced.

Information that the sender is requesting feedback about the outcome of the Replace action he has initiated.

Transmission of the information between network element RSA and network element RSB is dependent on whether this information was available when the MM_{B} was sent.

Network element RSB (MMS Relay/Server B)→receiving application UAB (MMS User Agent B) (upon notification about an MM which has been received), preferably in a message:

Information that the sender has replaced an MM_{A} available for download with a new MM_{B}. Both MMs are identified using the message references (URIs) relating to the MMs in question.

Information regarding when the MM_{A} available for download was replaced with the new MM_{B}. or:

Information that the sender wishes to change, in particular replace, an MM_{A} already delivered previously with a new MM_{B}. The MM_{A} being updated is identified using the individual Message-ID, and the MM_{B} intended to change, in particular replace, the MM_{A} is identified using the message reference (URI).

Receiving application UAB (MMS User Agent B)→network element RSB (MMS Relay/Server B) (after notification):

Information regarding whether the recipient was able to be informed about the Replace instruction.

If, in the case of the PULL mode, the recipient has been informed of the presence of an MM_{B} containing a Replace instruction, he/she can obtain it from the network element RSB using the known mechanisms. In the case of the PUSH mode, download of the MM_{B} is initiated by the MMS service provider and not by the recipient. In this case, the two previous steps, notification and confirmation of this, can be dispensed with.

Network element RSB (MMS Relay/Server B)→receiving application UAB (MMS User Agent B) (when an MM is delivered):

Flag indicating that the MM_{B} contains a Replace instruction which needs to be executed on the receiving application UAB.

Information regarding which already delivered MM_{A} needs to be changed, in particular replaced. The MM_{A} is identified using the individual Message-Identification number (Message-ID). or:

Information that the MM_{B} just delivered is a subsequently changed MM.

Information regarding when MM_{B} was changed by the sender.

Receiving application UAB (MMS User Agent B)→network element RSB (MMS Relay/Server B) (after an MM has been delivered):

Information regarding whether the Replace instruction was able to be executed successfully.

Information regarding whether the Replace instruction has been executed automatically.

Information regarding whether the recipient has been informed about the Replace operation (and/or has agreed to the Replace operation).

Network element RSB (MMS Relay/Server B)→network element RSA (MMS Relay/Server A) (only necessary if sender and recipient belong to different MMSEs and if the sender has requested feedback):

Information regarding whether the Replace instruction was able to be executed successfully.

Information regarding when the Replace instruction was executed.

Information regarding whether the Replace instruction has been executed automatically.

Information regarding whether the recipient has been informed about the Replace operation (and/or has agreed to the Replace operation).

Information regarding whether an already downloaded MM_{A} has been changed, in particular replaced, or else the MM_{A} had not yet been delivered before the Replace operation.

Identification number of the MM_{A} which has been changed, in particular replaced.

Network element RSA (MMS Relay/Server A)→sending application UAA (MMS User Agent A) (for the report):

Information regarding whether the Replace instruction was able to be executed successfully.

Information regarding when the Replace instruction was executed.

Information regarding whether the Replace instruction has been executed automatically.

Information regarding whether the recipient has been informed about the Replace operation (and/or has agreed to the Replace operation).

Information regarding whether an already downloaded MM_{A} has been changed, in particular replaced, or else the MM_{A} had not yet been delivered before the Replace operation.

Identification number of the MM_{A} which has been changed, in particular replaced.

Additional Service Feature: Conditional Replace

On the basis of one preferred embodiment of the present invention, the sender of the Replace command can specify conditions for implementing his/her requirement. In this context, the sending application UAA or the VAS application stipulates in what case the previously sent MM is replaced.

On the basis of the present invention, the service provider can limit the use of the “Replace” service feature to his/her own domains or to certain domains of the service providers. This can be done, for example, using an identification for the address of the recipient (call number, E-mail address or other). Another option would be to use an additional flag in the Replace command.

Conditional updating is preferably based on the editing phase for the message (in this case multimedia message MM) sent previously. In this case, the sender decides in what status of the MM it needs to be deleted. Possible conditions for changing, in particular replacing, are:

1. Replace the MM only if it is on the server and the recipient has not yet been made aware of this. The replacement is thus made only if no notification has been sent yet.

2. Replace the MM even if the notification has already been sent, but the MM has not yet been downloaded.

3. Replace the MM if the recipient has not yet opened it or read it. In this case, the replacement can also be made after download.

4. Replace the MM irrespective of the degree of editing of the MM with the recipient. In this case, an attempt at replacement is made even if the recipient has read the MM.

For implementing this service feature, a standard condition “default value” is advantageously adopted. By way of example, it may be agreed that the standard condition corresponds to one of the four cases described above. This default can, by way of example, be stipulated, so long as nothing explicit has been expressed regarding the conditional execution of the Replace command, such that the replacement needs to be made only before the notification, for example. The system could also be designed such that such replacement should be made only before the MM to be replaced has been downloaded or even after it has been opened or read.

The text below deals with the transactions for implementing the MM-status-dependent “Replace” service feature. An MM_{A} already sent can thus be recalled again subsequently by the sender by virtue of his/her composing a new MM_{B} which contains a Conditional Replace command and a new content (message body) intended for the recipient. This new message is sent to the same recipient as the MM_{A} sent previously. The replace identifier used is the identification number (ID 1) of the previously sent MM_{A} (see above). The MM_{B} containing the Replace information is first sent to the network element RSA of the sender. Here, a check is carried out to determine whether the MM_{A} with the ID 1 is still in the area of competence of the service provider A (MMSE_{A}) or whether it has already been forwarded to the MMSE_{B} of the service provider B. The former is the case, for example, if the time chosen by the sender for the desired delivery of his MM_{A} has not yet been reached; the latter is the case, for example, if the MM_{A} has not yet exceeded its validity period and has not yet been delivered to the receiving application UAB.

As soon as the MM_{A} has been found in an MMSE, the replacement of MM_{A} with MM_{B} can be started by the competent network element RS. If the original recipient has forwarded the MM sent to him/her to another address, the Replace command also needs to be forwarded by the network element RS as appropriate. If the network element RSB has only the information that the MM has been forwarded, without knowing the destination (for example, if the original recipient has forwarded the MM sent to him/her to an E-mail address), the sender of the Replace command can be informed about the failure of the recall on account of forwarding. For reasons of confidentiality, it would also be possible to announce failure of the operation without commenting on the reason in this case.

A particularly beneficial case for executing the Replace command is when the MM is still on one of the network elements RSA or RSB, and the receiving application UAB has not yet been notified about this message. Such a case could arise, for example, if the MM, at the request of the sender, is to be delivered at a particular time which has not yet actually occurred. In this case, the MM is still on the network element RSAL of the sender. The MM may also have been stored on the network element RSB; for example, if the recipient's terminal is switched off and the validity period of the MM has not been exceeded. In these two cases, the MM can be replaced irrespective of the selected deletion conditions. This is because all four of the replace conditions described above cover this situation.

If the receiving application UAB has already been informed about the MM_{A} available for it in the MMSE_{B} via a notification, and the MM_{A} should still be in the area of competence/memory of the service provider B, then, on the basis of the present invention, replacement can be executed only in the cases numbered 2, 3 and 4 above. For Conditional Replace case 1, the sender preferably receives an announcement containing the declaration that the recipient has already been informed about the previously sent MM and the replacement could not be executed. For the other cases (2, 3 and 4), a fresh notification can be used to make the receiving application UAB aware that the MM_{A} has been replaced with the MM_{B} and is thus no longer available for download. Instead, the receiver can request the new MM_{B}.

Should the MM_{A} already have been delivered to the recipient, replacement can be effected only for case 4 (Replace irrespective of the degree of editing) and, under some circumstances, for case 3 (Replace only if MM has not yet been opened/read). Preferably, a new notification is used to make the receiving application UAB aware, only for cases 3 and 4, that the sender wishes to replace the MM_{A}. This notification preferably contains the conditions for replacement. The MM_{A} therefore can be updated directly in the MMS User Agent B, provided that this is supported by the “Replace” service feature. If case 3 is involved, the MM is preferably replaced only if the terminal establishes that the MM has not yet been opened or read. For case 4, replacement is triggered irrespective of this. For cases 1 (Replace before notification) and 2 (Replace only before download), replacement cannot be effected. The sender preferably receives feedback containing the information that the MM could not be replaced, since a notification has already been sent (case 1) or because the MM has already been downloaded (case 2).

According to the present invention, another option for implementing the Replace action is to deliver the MM_{B} containing the Replace information as far as the receiving application UAB. Replacement is then triggered in the recipient's terminal by the MM_{B} and not by the notification coming from the MM_{B}. This case is not handled in more detail below.

The Replace instructor (sending application UAA or VAS application) is preferably informed in all the cases described about the outcome and possibly the date of execution of the action he has initiated, in particular if he requests this and if the MMS service providers involved allow this.

Since the Conditional Replace involves an MM which is intended to reach the receiving application UAB, MMSEs (Multimedia Messaging Service Environments) not supporting this service feature preferably treat the new MM_{B} as a simple MM. The new MM_{B} will therefore reach the receiving application UAB as a new MM, without replacing the MM_{A}. The sender is preferably also informed about this.

To be able to implement the “Conditional Replace” service feature just described, the present invention proposes that one or more of the following items of information additionally be interchanged between the authorities involved (sending application UAA, network element RSA, network element RSB and receiving application UAB). The bases taken are the current 3GPP specifications 3G TS 140 version 4.0.1 (see above), 3G TS 23.140 version 4.0.0 (see above), WAP specifications WAP-209-MMSEncapsulation, Release 2000 (see above), WAP-203 WSP (see above) and Report of the 3GPP TSG-T2 SWG3 (see above). The text below gives a more detailed explanation of the differences and additions as compared with the Unconditional Replace operation:

Sending application UAA (MMS User Agent A)→network element RSA (MMS Relay/Server A) (when sending an MM):

Conditions for execution of the Replace operation:

Replace only before notification.

Replace only before download, and also after a notification has been sent.

Replace only if the MM has not been opened/read.

Replace irrespective of the degree of editing of the MM (even after the MM_{A} has been read).

Network element RSA (MMS Relay/Server A)→sending application UAA (MMS User Agent A) (upon confirmation after an MM has been sent):

Notification by the service provider of whether he/she supports the Conditional Replace feature. In this case, the system could draw a distinction between support for “Replace” and “Conditional Replace”.

Network element RSA (MMS Relay/Server A)→network element RSB (MMS Relay/Server B) (only necessary if sender and recipient belong to different MMSEs):

Conditions for executing the Replace operation:

Replace only before notification.

Replace only before download, and also after a notification has been sent.

Replace only if the MM has not been read.

Replace irrespective of the degree of editing of the MM (even after reading).

Network element RSB (MMS Relay/Server B)→receiving application UAB (MMS User Agent B) (upon notification about the MM_{B} received):

Conditions for executing the Replace operation:

Replace only before download, and also after a notification has been sent. This condition is communicated only if the MM has not been downloaded.

Replace only if the MM has not been read.

Replace irrespective of the degree of editing of the MM (even after reading).

Receiving application UAB (MMS User Agent B)→network element RSB (MMS Relay/Server B) (after notification):

Information regarding whether the conditional replace instruction was able to be executed successfully.

In the event of failure, appropriate announcement, possibly giving reasons.

Network element RSB (MMS Relay/Server B)→network element RSA (MMS Relay/Server A) (only necessary if sender and recipient belong to different MMSEs and if the sender has requested feedback):

Information regarding whether the conditional replace instruction was able to be executed successfully.

In the event of failure, appropriate announcement, possibly giving reasons.

Network element RSA (MMS Relay/Server A)→sending application UAA (MMS User Agent A) (for the report):

Information regarding whether the conditional replace instruction was able to be executed successfully.

In the event of failure, appropriate announcement, possibly giving reasons.

Adjustments to the WAP Messages

The text below gives a more detailed explanation of possible modifications to the WAP messages for the Replace service feature. The adjustments and associations are illustrative and can be varied without reservation: to introduce the Replace service feature into the WAP implementation of MMS, the present invention proposes modifying the WAP messages M-Send.req, M-Send.conf, M-Notification.ind, M-NotifyResp.req, M-Retrieve.conf, M-Acknowledge.ind and M-Delivery.ind. In a similar way to in the procedure in section A (Recall service feature), various header fields in these WAP messages are advantageously extended or modified. The text below again refers to MMS User Agent and MMS Proxy/Server, which also mean MMS Client and MMS Proxy/Relay.

B.1 WAP Message M-Send.req (from Sending Application UAA to the Network Element RSA)

The sender of an MM wants to express that he subsequently wishes to change, in particular replace, his/her already sent MM_{A} with a new MM_{B}. Preferably, for this purpose, another header field is added to the WAP message M-Send.req used to send the new MM_{B}, the header field bearing the identification number of that MM needing to be changed, in particular replaced, with MM_{B} (namely ID1 for MM_{A} from FIG. 2). It is proposed that this header field have the name X-Mms-Replace-ID and the hexadecimal coding 0x81 (decimal: 129). Message-IDs are coded, in conformity with the encapsulation standard (see above), preferably in the form of a text string. In addition, the sender of an MM containing a Replace instruction is preferably provided with the opportunity to request feedback. To this end, it is proposed that the header field having the expedient name X-Mms-Request-Report and the hexadecimal coding 0x85 (decimal: 133), defined in section A.1, be introduced into the WAP message M-Send.req. The field values of this header field are advantageously coded in conformity with the encapsulation standard (see above) using the <Octet128> for “Feedback is required” and <Octet129> for “Feedback is not required”.

It is also proposed that, additionally, a new header field be added which conveys conditions for executing the Replace command. To this end, a header field which has the exemplary name X-Mms-Replace-Cond and preferably has the hexadecimal coding 0x87 (decimal: 135) is proposed. This header field is preferably coded using the <Octet128> for Replace only before notification, using the <Octet129> for Replace only before download, even after a notification has been sent, using the <Octet130> for Replace if not read (“Replace only before reading”) and using <Octet131> for Replace irrespective of the degree of editing of the MM, even after reading. If other conditions are introduced, appropriate field values preferably need to be added.

B.2 WAP Message M-Send.conf (from the Network Element RSA to the Sending Application UAA)

This WAP message can be used, on the basis of the present invention, to notify the sending application UAA of whether the service provider A has or has been able to deal with the Replace instruction from the sender (sending application UAA) appropriately. To this end, it is proposed that the header field expediently named X-Mms-Supported-Feature, which was introduced in section A.2 for the purposes of the Recall service feature, preferably also be used in this case. The field values used are then either the <Octet129> for “Replace feature supported” or the <Octet130> for “Not supported”.

In addition, it is proposed for the case of conditional replacement that the field values of the X-Mms-Supported-Feature, for example having the hexadecimal coding 0x83 (decimal: 131), be extended by the value <Octet132>. This value represents support of conditional changing or replacement. If the MM_{A} is still stored on the network element RSA, and the receiving application UAB has not yet been notified, the MM is replaced and sending application UAA is preferably informed about this operation. For this, the present invention proposes that the header field X-Mms-Status be added to the WAP message M-Send.conf. In this case, the new field value <Octet148> is preferably defined for “Replace successful, before notification”. In addition, it is proposed in this case that the new field value <Octet152> be stipulated for “Replace failed, since notification has been sent”. This coded value informs the sending application UAA, which wanted to have case 1 of Conditional Replace (Replace only before notification) executed, that it was not possible to update the MM_{A}, since the notification had already been sent. This case can arise if the sending application UAA and the receiving application UAB are associated with the same network element RS, that is to say network element RSA. In addition, other new field values are preferably defined:

<Octet149> for “Replace successful, before download”, and

<Octet153> for “Replace failed, since MM has been downloaded”.

The latter case can arise if the sender required case 2 of Conditional Replace (Replace before download).

B.3 WAP Message M-Notification.ind (from the Network Element RSB to the Receiving Application UAB)

On the basis of the present invention, a newly defined header field expediently named X-Mms-Replaced-URI and having the hexadecimal coding 0x82 (decimal: 130) is preferably extended in the WAP message M-Notification.ind. This header field can be used to inform the receiving application UAB, after notification has already been given, that the MM_{A} is no longer available for download under the URI specified because the sender has replaced it with a new MM_{B} having a different URI. The field value of this newly defined header field is advantageously coded as a text string in conformity with the encapsulation standard (see above). To be able to inform the receiving application UAB about the time of updating, on the basis of one advantageous variant of the present invention, the header field expediently named X-Mms-Date-Of-Execution newly defined in section A.3 is extended.

If the MM_{A} to be changed, in particular to be replaced, is already on the receiving application UAB, the header field expediently named X-Mms-Replace-ID and having the hexadecimal coding 0x81 (decimal: 129), newly defined in section B.1, is advantageously extended in the WAP message M-Notification.ind. The receiving application UAB recognizes from this that the MM_{B} available for download contains a Replace command for the MM_{A} having the appropriate Message-Identification number. Downloading of the MM_{B} can then be initiated either in PUSH mode or in PULL mode, depending on the user's settings, on the MMS service provider's settings and/or on the network operator's settings.

As mentioned, the WAP message M-Notification.ind informs the receiving application UAB about the arrival of the message MM_{B} intended to change, in particular replace, the MM_{A}. For conditional replacement, the receiving application UAB needs to be informed about the conditions of replacement. For this, the newly defined header field X-Mms-Replace-Cond having the hexadecimal coding 0x87 (decimal: 135) is preferably used. In this case, only the coded values <Octet130> for Replace only if the MM has not been read and <Octet131> for Replace irrespective of the degree of editing of the MM (even after reading) are required. <Octet128> for Replace only before notification and <Octet129> for Replace only before download, even after a notification has been sent, are not required in this case, since in both cases the MM should be replaced before the notification has been sent. If the conditions for replacing the MM_{A} have been satisfied, this MM can actually be deleted even before MM_{B} arrives in the receiving application UAB.

B.4 WAP Message M-NotifyResp.ind (from Receiving Application UAB to the Network Element RSB)

The present invention proposes inserting the header field X-Mms-Status defined in the encapsulation standard (see above) into the WAP message M-NotifyResp.ind. So that it is possible to notify the network element RS of whether or not it has been possible to execute j the sender's Replace instruction successfully in PUSH mode, it is also necessary to extend this header field in this case (in a similar manner to the procedure in section A, Recall service feature): in the present invention, the feedback is preferably given using the two new field values <Octet134> for “Replace instruction has been executed successfully” and <Octet135> for “Replace instruction could not be executed”.

In addition to the field values <Octet134> and <Octet135> proposed previously and the field value <Octet148> proposed above for “Replace successful, before notification” and <Octet152> for “Replace failed, since notification has been sent”, the following field values are proposed:

<Octet150> for “Replace successful, before MM has been read”

<Octet151> for “Replace successful, after MM has been read”

<Octet154> for “Replace failed, since MM has been read”

<Octet155> for “Replace failed, since MM has been deleted”.

These notifications allow the sender of the Replace command to be informed about the exact outcome of his/her order.

B.5 WAP Message M-Retrieve.conf (from the Network Element RSB to the Receiving Application UAB)

If the MM_{A} to be replaced has already been able to be replaced in the MMSE_{B} with MM_{B}, the present invention makes it possible preferably to insert the extended header field X-Mms-Status defined in the encapsulation standard (see above), having the field value <Octet134> for “Replace successful”, and the header field expediently named X-Mms-Date-of-Execution, newly defined in section A.3, into the WAP message M-Retrieve.conf used to transmit MM_{B} to the receiving application UAB. This allows the network element RSB to signal to the receiving application UAB that the MM_{B} is a subsequently replaced MM, and when the sender's Replace instruction has been executed in the area of competence of the MMSE_{B}.

If the MM_{A} to be replaced is already on the receiving application UAB, it is advantageous, on the basis of the present invention, likewise to extend the header field named X-Mms-Replace-ID defined in section B.1 in the WAP message M-Retrieve.conf. This header field can be used to initiate replacement of the MM_{A} on the receiving application UAB using the Message-ID (see FIG. 2), if the receiving application UAB supports the Replace service feature. Otherwise, this merely indicates to the recipient that the sender wanted to replace the MM_{A} with the new MM_{B}.

In the case of conditional replacement, it is proposed that the header field X-Mms-Replace-Cond newly defined above advantageously be added to this message. In this context, the field values <Octet130> for “Replace only if the MM has not been read” and <Octet131> for “Replace irrespective of the degree of editing of the MM”, i.e. even after reading, can be used. This informs the receiving application UAB in what case the old MM needs to be replaced.

B.6 WAP Message M-Acknowledge.ind (from Receiving Application UAB to the Network Element RSB)

On the basis of the present invention, one advantageous development proposes inserting the header field X-Mms-Status defined in the encapsulation standard (see above) into the WAP message M-Acknowledgement.ind. So that it is possible to notify the network element RS of whether or not it has been possible to execute the sender's Replace instruction successfully in PULL mode, it is also necessary to extend this header field in this case (in a similar way to the procedure in section A, Recall service feature): in the present invention, the feedback is advantageously given using the two new field values <Octet134> for “Replace instruction has been executed successfully” and <Octet135> for “Replace instruction could not be executed”.

In addition, it is possible to use the field values <Octet149>, <Octet150>, <Octet151>, <Octet153>, <Octet154> and <Octet155> (see above).

B.7 WAP Message M-Delivery.ind (from Network Element RSA to the Sending Application UAA)

In addition, it is proposed that the header field X-Mms-Status extended in sections B.4 and B.6 be inserted in this case too. This header field can be used to notify the sender (sending application UAA) of whether or not it has been possible to execute his/her Replace instruction successfully, if the aforementioned new field values are used in this case too, with some or all of the values described above possibly arising. In addition, the sender is advantageously informed about the date on which his/her Replace instruction was executed using the header field expediently named X-Mms-Date-of-Execution defined in section A.3.

Another way of informing the sender of a Conditional Replace command about execution of the Replace instruction can be provided, on the basis of the present invention, by defining a new header field which is used in the appropriate WAP messages. To this end, a header field having the exemplary name X-Mms-Replace-Status is proposed. This header field can be used in the cases described above as a replacement for the extended header field X-Mms-Status. The latter can also be used in the form defined in the WAP-209-MMSEncapsulation, Release 2000 (see above). The new header field preferably contains only information relating to the execution of the Replace instruction. For the X-Mms-Replace-Status, the hexadecimal coding 0x89 (decimal: 137) is proposed. The possible field values which cover the various execution scenarios are, by way of example:

<Octet128> for “Replace successful”

<Octet129> for “Replace successful, before notification”

<Octet130> for “Replace successful, before download”

<Octet131> for “Replace successful, before MM has been read”

<Octet132> for “Replace successful, after MM has been read”

<Octet133> for “Replace failed”

<Octet134> for “Replace failed, since notification has been sent”

<Octet135> for “Replace failed, since MM has been downloaded”

<Octet136> for “Replace failed, since MM has been read”

<Octet137> for “Replace failed, since message has been deleted”

<Octet138> for “Replace failed, message not found”

<Octet139> for “Replace failed, message forwarded”.

For other reasons or conditions, the field values and codings can be extended as appropriate.

Another alternative to the X-Mms-Replace-Status together with the header field X-Mms-Replace-Status introduced above would be, on the basis of the present invention, a new header field which can be used for the feedback relating to execution of the Replace command and the Recall command. For this, a header field having the exemplary name X-Mms-Operation-Status is proposed. This header field can have the hexadecimal coding 0x90 (decimal: 138), together with the following field values:

<Octet128> for “Operation successful”

<Octet129> for “Operation successful, before notification”

<Octet130> for “Operation successful, before download”

<Octet131> for “Operation successful, before MM has been read”

<Octet132> for “Operation successful, after MM has been read”

<Octet133> for “Operation failed”

<Octet134> for “Operation failed, since notification has been sent”

<Octet135> for “Operation failed, since MM has been downloaded”

<Octet136> for “Operation failed, since MM has been read”

<Octet137> for “Operation failed, since message has been deleted”

<Octet138> for “Operation failed, message not found”

<Octet139> for “Operation failed, message forwarded”.

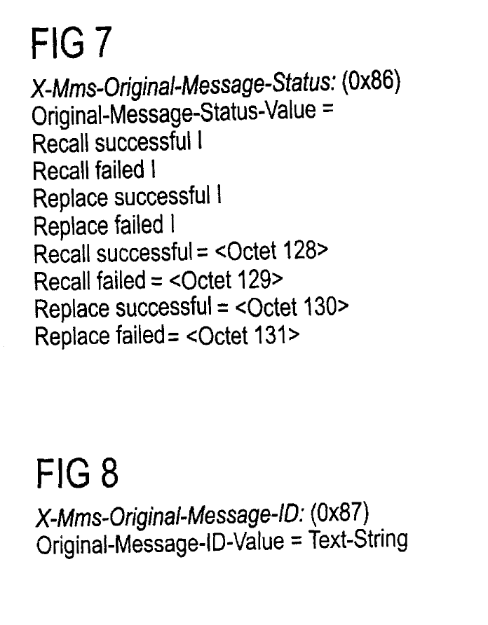

FIG. 5 shows, once again, seven, newly introduced header fields including the codings for the field name and the field value. FIG. 6 shows the header field X-Mms-Status extended by new field values. FIGS. 7 and 8 show the header fields of the alternative implementation options (exemplary embodiments 3 and 4, see below). The relevant additions in the header fields of the relevant WAP messages are listed in Tables 2 to 8 at the end of the description. It is entirely possible for only single additions to be made in these header fields as well.

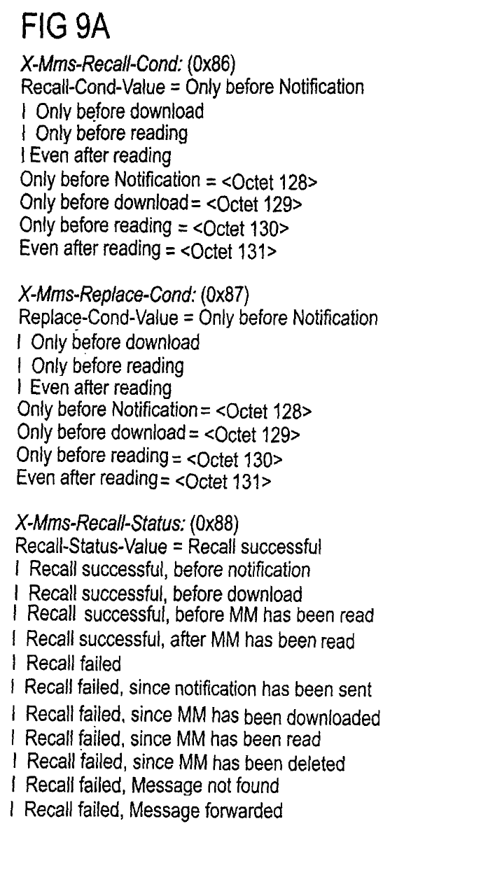

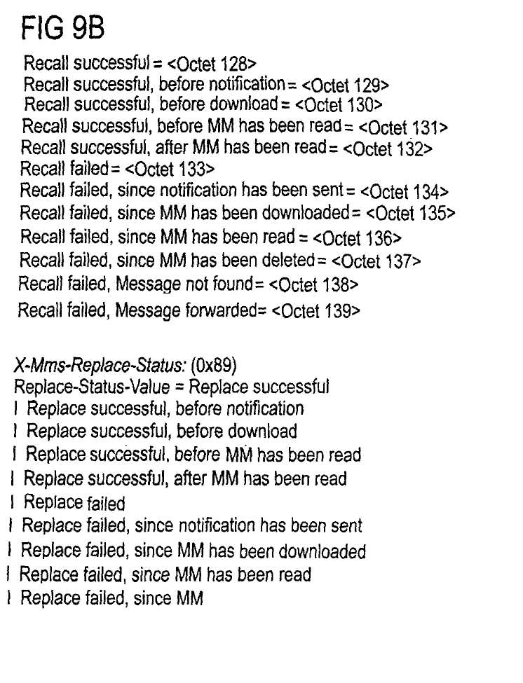

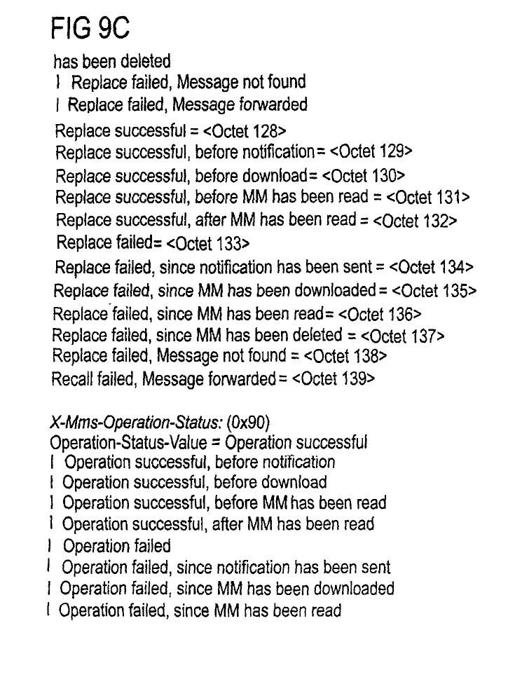

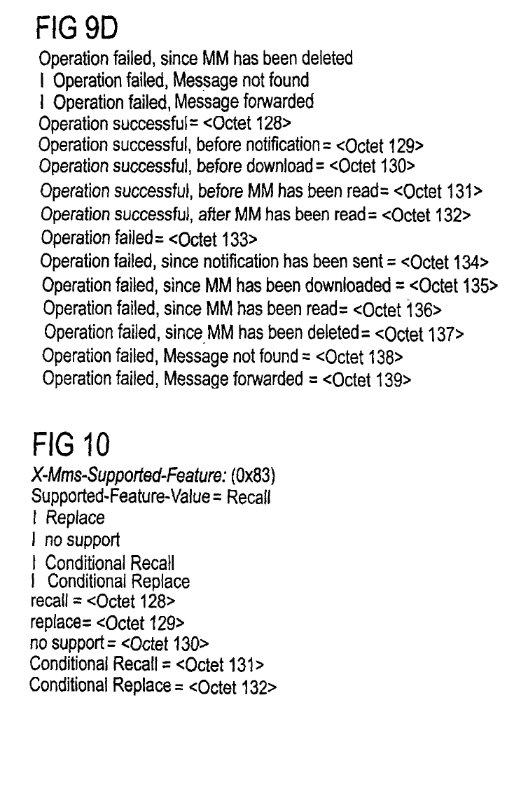

For the case of conditional manipulation, FIG. 9 shows the newly introduced header fields Mms-Recall-Cond, X-Mms-Replace-Cond, X-Mms-Recall-Status, X-Mms-Replace-Status and X-Mms-Operation-Status, including the codings for the field name and the field value. FIG. 10 shows the header field X-Mms-Supported-Feature extended by new field values. The header field X-Mms-Status shown in FIG. 6 likewise contains new field values relating to conditional manipulation.

C. Binary Coding

C.1 No Condition for Recall or Replace

The exemplary embodiments below give a detailed description of the header fields used in the WAP messages without conditions first being provided for recalling or replacing a first message. In this context, the following scenario is assumed by way of example: sending application UAA sends an MM_{A} comprising a text and a JPEG image to a recipient and wants to recall it (example 1) or replace it with a new MM_{B} (example 2) at a later time.

M-Send.req (sending application UAA→network element RSA):

X-Mms-Message-Type: m-send-req

X-Mms-Transaction-ID: 10

X-Mms-Version: 1.0

Date: Thu, 26 Oct 2000 12:12:19 +0100

From: abc@siemens.de

To: xyz@siemens.de

Subject: multimedia message a

Content-Type: multipart/related; boundary=“-----_=_NextPart_{—}000_”

-----_=_NextPart_{—}000_{—}

Content-Type: text/plain; name=“meetingtxt”

Content-Transfer-Encoding: quoted-printable

Hello, xyz

Here is the required agenda

for our next meeting.

Regards, abc

-----_=_NextPart_{—}000_{—}

Content-Type: image/jpeg: name=“agendajpg”

Content-Transfer-Encoding: base64

Content-ID: <1725782>

. . .

-----_=_NextPart_{—}000_--

The sending application UAA of the user having the address abc@siemens.de sends an MM_{A} including a text (MIME content type “text/plain”) and a JPEG image (MIME content type “image/jpeg”) to the receiving application UAB of the user having the address xyz@siemens.de. The WAP message M-Send.req used for this purpose bears, by way of example, the transaction identity number ID10. The network element RSA then allocates an individual identification number for the MM_{A} sent and uses the WAP message M-Send.conf to confirm that the WAP message M-Send.req has been transmitted to the network element RSA correctly:

M-Send.conf (network element RSA→sending application UAA):

X-Mms-Message-Type: m-send-conf

X-Mms-Transaction-ID: 10

X-Mms-Version: 1.0

X-Mms-Response-Status: ok

Message-ID: AAAA.1111@mms-relay01.siemens.de

In the two WAP messages M-send.req and M-Send.conf, the same transaction identity number (Transaction-ID) is used. This allows the WAP message M-Send.conf to be clearly assigned to the associated WAP messages M-Send.req on the sending application UAA using the Message-Identification number, wherein the individual identification number AAAA.1111@mms-relay01.siemens.de can be assigned to the MM_{A} sent. The network element RSA has allocated the individual identification number AAAA.1111@mms-relay01.siemens.de for the MM_{A}, in this example for the sending application UAA/network element RSA interface. This identification number is contained in the header field Message-ID.

### EXAMPLE 1

### Recall (Unconditional)

The sender of the MM_{A} wishes to recall it (two hours later). On the basis of the present invention, this is done using a new MM_{B} sent to the same recipient as the MM_{A} intended to be recalled. At this point, the header field expediently named X-Mms-Recall-ID, newly defined on the basis of the present invention, is advantageously used in the WAP message M-Send.req, with the Message-ID of the MM_{A} intended to be recalled being entered into said header field (ID1 in FIG. 2). In addition, the WAP message M-Send.req advantageously contains the header field expediently named X-Mms-Request-Report which has likewise been newly defined on the basis of the present invention and which can be used to request feedback about the Recall instruction issued. For a Recall instruction, the WAP message M-Send.req preferably contains only the header fields and no other multimedia content (“message body”). The newly defined header fields are in boxes, as is also the case below.

M-Send.req (sending application UAA→network element RSA):

X-Mms-Message-Type: m-send-req
X-Mms-Transaction-ID: 16
X-Mms-Version: 1.0
Date: Thu, 26 Oct 2000 14:12.19 +0100
From: abc@sal.siemens.de
To. xyz@sal.siemens.de
X-Mms-Recall-ID: AAAA.1111@mms-relay01.siemens.de
X-Mms-Request-Report: Yes
Subject: recall of multimedia message a
Content-Type: text/plain

Receipt of the WAP message M-Send.req with the Recall command in MM_{B} is advantageously also acknowledged immediately by the network element RSA using a WAP message M-Send.conf The latter contains the Message-Identification number allocated by the network element RSA for the MM_{B} (in this case: AAAA.2222@mms-relay01.siemens.de). It also advantageously contains the header field X-Mms-Supported-Feature which has been newly defined on the basis of the present invention and which can be used to indicate to the sending application UAA whether the service provider A supports the Recall service feature (as shown in the present case), or whether it does not.

M-Send.conf (network element RSA→sending application UAA):

X-Mms-Message-Type: m-send-conf
X-Mms-Transaction-ID: 16
X-Mms-Version: 1.0
X-Mms-Response-Status: ok
Message-ID: AAAA.2222@mms-relay01.siemens.de
X-Mms-Supported-Feature: recall

When interchanging WAP messages at the reception end (interface between network element RSB and receiving application UAB), it is necessary to decide whether the receiving application UAB

1. has not yet been informed about an MM which has arrived, or

2. has actually been notified but has not yet retrieved the MM, or

3. has already received the MM.

In the first and second cases, the MM_{A} and the MM_{B} containing the Recall command can be deleted in the area of competence of the service provider B (MMSE_{B}). In the first case, the recipient does not actually need to be made aware of this. In the second case, however, the receiving application UAB preferably needs to be informed by the service provider B that the MM_{A} is no longer available to it for downloading if the sender has subsequently recalled it. To this end, the present invention allows the WAP message M-Notification.ind to be used:

2nd case: M-Notification.ind (network element RSB→receiving application UAB):

X-Mms-Message-Type: m-notification-ind
X-Mms-Transaction-ID: 20
X-Mms-Version: 1.0
From: abc@sal.siemens.de
X-Mms-Message-Class: Personal
X-Mms-Message-Size: 42
X-Mms-Expiry: 3600
X-Mms-Content-Location: http://mms-
relay02.siemens.de/default-recall-message
X-Mms-Recalled-URI: http://mms-
relay02.siemens.de/BBBB.3333
X-Mms-Date-Of-Execution: Thu, 26 Oct 2000 14:14:54 +0100

In the WAP message M-Notification.ind, only the URI can be used for identifying the recalled MM_{A}, since the network element RS has not yet allocated a “Message-ID” for the recalled MM_{A} at this moment (this is done only upon download). The header fields X-Mms-Recalled-URI and X-Mms-Date-Of-Execution distinguish this Recall notification from a “conventional” notification. In this example, the header field X-Mms-Content-Location refers to a URI whose memory location advantageously contains a standard text message from the service provider B (e.g.: “The MM has been deleted again by the sender”). As such, sending and/or receiving applications which do not understand the new header fields of the Recall service feature can also be subsequently informed about a Recall instruction which has been executed.

The WAP message M-NotifyResp.req is used to confirm correct receipt of the WAP message M-Notification.ind. In this example, the header field X-Mms-Status holds one of the entries newly defined on the basis of the present invention (namely “Recall feature supported”), which entry can be used to make the network element RSB aware that the receiving application UAB has understood the second notification containing the information about the recall.

2nd case (again): M-NotifyResp.req (receiving application UAB→network element RSB):

X-Mms-Message-Type: m-notifyresp-req
X-Mms-Transaction-ID: 20
X-Mms-Version: 1.0
X-Mms-Status: recall feature supported

If, however, the MM_{A} needing to be deleted has already been transmitted to the receiving application UAB (third case), the WAP message M-Notification.ind advantageously and expediently contains not the notification about the recall which has already been executed, but rather the Recall command itself, specifically in the form of the header field expediently named X-Mms-Recall-ID in which the identification number of the MM_{A} needing to be recalled is entered. In this case, the identification number (and not the URI) is preferably used, because it is known both to the network element RSB and to the receiving application UAB after the download executed beforehand (in the third case described here).

3rd case: M-Notification.ind (network element RSB→receiving application UAB):

X-Mms-Message-Type: m-notification-ind
X-Mms-Transaction-ID: 25
X-Mms-Version: 1.0
From: abc@sal.siemens.de
X-Mms-Message-Class: Personal
X-Mms-Message-Size: 42
X-Mms-Expiry: 3600
X-Mms-Content-Location: http://mms-
relay02.siemens.de/default-recall-message
X-Mms-Recall-ID: BBBB.3333@mms-
relay02.siemens.de

In this example, the header field X-Mms-Content-Location refers to a URI whose memory location holds a standard text message from the service provider B (e.g.: “The sender wishes to recall the MM having the Message-ID BBBB.3333@mms-relay02.siemens.de.”). As such, sending and/or receiving applications which do not understand the new header fields of the Recall service feature can also be subsequently informed about a Recall instruction sent by the sender.

To emphasize that the MM_{A} on this interface can have a different “Message-ID”, the value which has been chosen in this exemplary embodiment is BBBB.3333@mms-relay02.siemens.de (corresponds to ID2 of MM_{A} in FIG. 2).

3rd case (again): M-NotifyResp.req (receiving application UAB→network element RSB):

X-Mms-Message-Type: m-notifyresp-req
X-Mms-Transaction-ID: 25
X-Mms-Version: 1.0
X-Mms-Status: recall successful

In this exemplary embodiment, the receiving application UAB returns feedback to the network element RSB with the WAP message M-NotifyResp.req. To this end, the header field X-Mms-Status extended in the present invention, from the encapsulation standard (see above), is advantageously used. In this exemplary embodiment, it has been possible to delete the MM_{A} on the receiving application UAB, which is expressed using the field value “Recall successful”. In the network element RSB, the Transaction-ID (in this case: 25) of the WAP message pair can be used to infer the Message-Identification number (in this case: BBBB.3333@mms-relay02.siemens.de) of the deleted MM_{A}. This makes it possible to compile feedback if this is required by the sender and is supported by the service provider B.

M-Delivery.ind (network element RSA→sending application UAA):

X-Mms-Message-Type: m-delivery-ind
X-Mms-Message-ID: AAAA.2222@mms-relay01.siemens.de
X-Mms-Version: 1.0
To: abc@sal.siemens.de
Date: Thu, 26. Oct 2000 14:14:09 +0100
X-Mms-Status: recall successful

If the sender requires feedback for the Recall instruction he/she has initiated, the MMS Relay/Server A can use the WAP message M-Delivery.ind to send back feedback to the sending application UAA. The “Message-ID” field contains the identification number of the Recall instruction. For the status of the Recall, the extended header field X-Mms-Status, in which the successful deletion of the MM_{A} is confirmed using the field value “Recall successful”, is likewise advantageously used in this case. Since the sending application UAA knows the relationship between the Message-Identification number of the Recall instruction and the Message-Identification number of the MM_{A} which is supposed to be recalled, it is possible to notify the sender of whether or not his/her Recall instruction was able to be executed successfully (if this is supported by the MMS service providers involved).

### EXAMPLE 2

### Replace (Unconditional)

In this example, the sender wishes to update his/her MM_{A} (one hour after it has been sent): of the two elements originally sent, it is now intended that only the JPEG image (MIME content type “image/jpeg”) be retained. In addition, the subject needs to be changed to “Agenda for our meeting”.

On the basis of the present invention, a new MM_{B} is sent to the same recipient as the MM_{A} sent previously which needs to be changed or replaced. To this end, the header field expediently named X-Mms-Replace-ID, newly defined on the basis of the present invention, is advantageously used and has the “Message-ID” of the MM_{A} entered into it. In addition, the WAP message M-Send.req advantageously contains the header field expediently named X-Mms-Request-Report, likewise newly defined on the basis of the present invention, which can be used to request feedback about the Replace instruction issued (as shown in this example).

M-Send.req (sending application UAA→network element RSA):

X-Mms-Message-Type: m-send-req
X-Mms-Transaction-ID: 32
X-Mms-Version: 1.0
Date: Thu, 26 Oct 2000 13:12:11 +0100
From: abc@sal.siemens.de
To: xyz@sal.siemens.de
X-Mms-Replace-ID: AAAA.1111@mms-
relay01.siemens.de
X-Mms-Request-Report: Yes
Subject: Agenda for our meeting
Content-Type: multipart/related; boundary=”-----
_=_NextPart_023_”
---_=_NextPart_023_
Content-Type: image/jpeg; name=”agenda.jpg”
Content-Transfer-Encoding: base64
Content-ID: <1725782>
...
-----_=_NextPart_023_--

Receipt of this WAP message M-Send.req, which contains the MM_{B} with the Replace command, is also preferably acknowledged immediately by the network element RSA using a WAP message M-Send-conf The latter expediently contains the Message-Identification number (Message-ID) of the MM_{B} (in this case: AAAA.5555@mms-relay01.siemens.de), which identification number has been allocated by the network element RSA, and the header field X-Mms-Supported-Feature, which has likewise been newly defined on the basis of the present invention and which can be used to indicate to the sending application UAA whether or not the service provider A supports the Replace service feature. In this example, the two WAP messages have the transaction identity number IDD32.

M-Send.conf (network element RSA→sending application UAA):

X-Mms-Message-Type: m-send-conf
X-Mms-Transaction-ID: 32
X-Mms-Version: 1.0
X-Mms-Response-Status: ok
Message-ID: AAAA.5555@mms-relay01.siemens.de
X-Mms-Supported-Feature: replace

When interchanging WAP messages at the reception end (interface between network element RSB and receiving application UAB), it is necessary to decide whether the receiving application UAB

1. has not yet been informed about an MM which has arrived, or

2. has actually been notified but has not yet retrieved the MM, or

3. has already received the MM.

In the first and second cases, the MM_{A} can be changed, in particular replaced, by the MM_{B} in the area of competence of the service provider B (MMSE_{B}). The present invention makes it possible for the recipient, in the first case, to be made aware, both upon notification and upon download, that the MM has subsequently been changed, in particular replaced, and when the Replace instruction was executed. Preferably, in the second case, the service provider B can inform the receiving application UAB immediately after the Replace instruction has been executed in the MMSE_{B} that the sender has updated MM_{A} with a new MM_{B}, and when this update was carried out. On the basis of the present invention, this notification is preferably intended to be given using the WAP message M-Notification.ind, in which only the URI can be used for identifying the changed, in particular replaced, MM_{A}, since the network element RSB has not yet allocated a Message-Identification number (“Message-ID”) for the MM_{A} at this moment (this is done only when the MM_{A} is downloaded). The header fields X-Mms-Replaced-URI and X-Mms-Date-Of-Execution distinguish this Recall notification from a “conventional” notification. The header field X-Mms-Content-Location indicates where the MM_{B} with the now current content can be found on the server.

2nd case: M-Notification.ind (network element RSB→receiving application UAB):

X-Mms-Message-Type: m-notification-ind
X-Mms-Transaction-ID: 35
X-Mms-Version: 1.0
From: abc@sal.siemens.de
X-Mms-Message-Class: Personal
X-Mms-Message-Size: 45
X-Mms-Expiry: 3600
X-Mms-Content-Location: http://mms-
relay02.siemens.de/BBBB.4444
X-Mms-Replaced-URI: http://mms-
relay02.siemens.de/BBBB.3333
X-Mms-Date-Of-Execution: Thu, 26 Oct 2000 13:15:09 +0100

The WAP message M-NotifyResp.req is advantageously used by the receiving application UAB to confirm correct receipt of the WAP message M-Notification.ind, cf. FIG. 2. In this example, the header field X-Mms-Status contains an entry newly defined on the basis of the present invention (namely “Replace feature supported”), which is used to make the network element RSB aware that the receiving application UAB has understood the second notification containing the information about the Replace instruction executed.

2nd case (again): M-NotifyResp.req (receiving application UAB→network element RSB):

X-Mms-Message-Type: m-notifyresp-req
X-Mms-Transaction-ID: 35
X-Mms-Version: 1.0
X-Mms-Status: replace feature supported

If, however, the MM_{A} needing to be replaced has already been transmitted to the receiving application UAB (third case), then, on the basis of the present invention, the WAP message M-Notification.ind advantageously contains not the notification about a replacement which has already taken place, but rather the Replace command itself, specifically in the form of the header field expediently named X-Mms-Replace-ID, which contains the identification number of the MM_{A} needing to be changed, in particular to be replaced. The receiving application UAB can then initiate download of the MM_{B} either in PUSH mode or in PULL mode using the WSP GET command. In this example, the header field X-Mms-Content-Location refers to a URI whose memory location contains a standard text message from the service provider B (e.g.: “The sender wishes to replace the MM having the Message-IDBBBB.3333@mms-relay02.siemens.de subsequently.”). As such, that receiving applications which do not understand the new header fields of the Recall service feature can also be subsequently informed about a Replace instruction sent by the sender.

3rd case: M-Notification.ind (network element RSB→receiving application UAB):

X-Mms-Message-Type: m-notification-ind
X-Mms-Transaction-ID: 38
X-Mms-Version: 1.0
From: abc@sal.siemens.de
X-Mms-Message-Class: Personal
X-Mms-Message-Size: 45
X-Mms-Expiry: 3600
X-Mms-Content-Location: http://mms-
relay02.siemens.de/default-replace-message
X-Mms-Replace-ID: BBBB.3333@mms-
relay02.siemens.de

As a response to the WSP GET command used to send the URI to the network element RSB, the receiving application UAB receives the MM_{B} with the altered title and the altered multimedia content (now only a JPEG image) for changing or replacing MM_{A} in the WAP message M-Retrieve.conf. In the WAP message M-Retrieve.conf too, the header field expediently named X-Mms-Replace-ID is advantageously intended to be extended. As such, the MM_{A} can be changed, in particular replaced, with the MM_{B} directly on the receiving application UAB, if the receiving application UAB supports the Replace service feature. Depending on the chosen mode of delivery, the transaction identity number is adopted in the WAP message M-Retrieve.conf from the WAP message M-Notification.ind (PUSH mode), or a new one is allocated (PULL mode).

3rd case (again): M-Retrieve.conf (network element RSB→receiving application UAB):

X-Mms-Message-Type: m-retrieve-conf
X-Mms-Transaction-ID: 38 or 48
Message-ID: BBBB.4444@mms-relay02.siemens.de
X-Mms-Version: 1.0
Date: Thu, 26 Oct 2000 13:12:11 +0100
From: abc@sal.siemens.de
X-Mms-Message-Class: Personal
X-Mms-Message-Size: 42
X-Mms-Expiry: 3600
X-Mms-Replace-ID: BBBB.3333@mms-
relay02.siemens.de
Subject: Agenda for our meeting
Content-Type: multipart/related: boundary=“-----
_=_NextPart_023_”
-----_=_NextPart_023_{—}
Content-Type: image/jpeg; name=“agenda.jpg”
Content-Transfer-Encoding: base64
Content-ID: <1725782>
...
-----_=_NextPart_023_--

To emphasize that the MM_{A} can have a different Message-Identification number (“Message-ID”) at this interface, the value which has been chosen in this exemplary embodiment is BBBB.3333@mms-relay02.siemens.de (corresponds to ID2 in FIG. 2).

When MM_{B} is delivered in PULL mode:

3rd case: M-Acknowledge.ind (receiving application UAB→network element RSB):

X-Mms-Message-Type: m-acknowledge-ind
X-Mms-Transaction-ID: 48
X-Mms-Version: 1.0
X-Mms-Status: replace successful

If the MM_{B} has been delivered in PULL mode, the receiving application UAB preferably uses the WAP message M-Acknowledge.ind to send back feedback to the network element RSB. To this end, the header field X-Mms-Status extended on the basis of the present invention is used. In this exemplary embodiment, the MM_{A} has been able to be replaced with the new MM_{B} on the receiving application UAB, which is expressed using the field value “Replace successful”. In the network element RSB, the transaction ID (Transaction-ID) (in this case: 48) of the WAP message pair M-Retrieve.conf and M-Acknowledge.ind can be used to infer the Message-ID (in this case: BBBB.3333@mms-relay02.siemens.de) of the replaced MM_{A}. This makes it possible to compile feedback if this is required by the sender and is supported by the service provider B.

When MM_{B} is delivered in PUSH mode

X-Mms-Message-Type: m-notifyresp-req
X-Mms-Transaction-ID: 38
X-Mms-Version: 1.0
X-Mms-Status: replace successful

If the MM_{B} has been delivered in PUSH mode, the receiving application UAB confirms correct receipt of MM_{B} preferably using the WAP message M-NotifyResp.req. To this end, the header field X-Mms-Status extended in the present invention is preferably used. In this exemplary embodiment, the MM_{A} has been able to be replaced with the new MM_{B} on the receiving application UAB, which is expressed using the field value “Replace successful”. In the network element RSB, the transaction ID (in this case: 38) of the WAP message triple M-Notification.ind, M-Retrieve.conf and M-NotifyResp.req can be used to infer the Message-ID (in this case: BBBB.3333@mms-relay02.siemens.de) of the replaced MM_{A}. This makes it possible to compile feedback if this is required by the sender and is supported by the service provider B.

M-Delivery.ind (network element RSA→sending application UAA):

X-Mms-Message-Type: m-delivery-ind
X-Mms-Message-ID: AAAA.5555@mms-relay01.siemens.de
X-Mms-Version: 1.0
To: abc@sal.siemens.de
Date: Thu, 26 Oct 2000 13:12:11 +0100
X-Mms-Status: replace successful

The network element RSA can use the WAP message M-Delivery.ind to send back feedback to the sending application UAA. The field Message-ID contains the ID of the Replace instruction. For the status of the Replace instruction, the extended header field X-Mms-Status, in which successful replacement of the MM_{A} with MM_{B} is confirmed using the field value “Replace successful”, is preferably likewise used in this case. Since the sending application UAA knows the relationship between the Message-ID of the Replace instruction and the Message-ID of the MM_{A} which should be recalled, the sender can be notified of whether or not his Replace instruction was able to be executed successfully (if the service providers involved support this).

### EXAMPLE 3

### Alternative for Sending Status Information (Unconditional)

In the two exemplary embodiments described previously, feedback about the outcome of a Recall or Replace instruction issued is transmitted from the receiving application UAB to the network element RSB (in the case of service provider B) using the WAP messages M-NotifyResp.ind (PUSH mode) or M-Acknowledgement.ind (PULL mode), or from the network element RSA to the sending application UAA (in the case of service provider A) using the WAP message M-Delivery.ind. To this end, new field values have been introduced into the header field X-Mms-Status. Although this procedure is efficient, it is not entirely in conformity with the previous use of the header field X-Mms-Status. The text below therefore describes an alternative exemplary embodiment for sending feedback. In this context, the sending and execution of a Recall or Replace instruction is expediently left unchanged as described in example 1 and example 2.

With this alternative, the header field X-Mms-Status (as originally provided in the encapsulation standard (see above)) continues to be used exclusively to inform the sender about the status of the last MM sent (that is to say the one which contained the Recall or Replace instruction) and not (as described for exemplary embodiments 1 and 2) about the outcome of a Recall or Replace instruction. For this case, a further header field is therefore defined which can be used to make the sender aware about the outcome of his/her Recall or Replace instruction. It is proposed that this new header field be given the name X-Mms-Original-Message-Status and that it be given the hexadecimal coding 0x86 (decimal: 134). It is also proposed that, by way of example, the field values used be <Octet128> for “The MM has been recalled successfully”, <Octet129> for “Recall of the MM has failed”, <Octet130> for “The MM has been successfully changed/replaced” and <Octet131> for “Change/Replace has failed for the MM”. FIG. 7 shows the header field presented in this alternative.

### EXAMPLE 4

### Alternative for Sending Feedback (Unconditional)

In Examples 1 and 2, the MM_{A} to which the feedback refers was identified from the result of the Recall or Replace instruction using the Message-ID of MM_{B} and using the transaction IDs in the WAP messages M-NotifyResp.ind or M-Acknowledge.ind.

It is also conceivable for the Message-ID of that MM_{A} which has been recalled or changed, in particular replaced, to be transmitted directly with the WAP messages M-NotifyResp.ind or M-Acknowledgement.ind (to service provider B) or M-Delivery.ind (from service provider A). To this end, it is proposed that a new header field be introduced which, by way of example, is expediently named X-Mms-Original-Message-ID, and that it be given the hexadecimal coding 0x87 (decimal: 135). The field values of this new header field preferably contain the Message-ID of the original MM_{A} and are coded in the form of a text string on the basis of the encapsulation standard (see above). FIG. 8 shows the header field presented in this alternative.

C.2 Condition for Recall or Replace

In the exemplary embodiments which now follow, a detailed description is given of the header fields used in the WAP messages for conditional recall and replacement of a first message. In this context, the following scenario is adopted by way of example: an MMS VAS application A sends an MM_{A} to a recipient and later wishes to recall it (example 5) or to replace it with a new MM_{B} (example 6). Within the WAP message M-Send.conf, the MM_{A} sent is assigned an individual identification number (AAAA.1111@mms-relay01.siemens.de). This Message-ID 1 is used to identify the MM_{A} for Recall and Replace operations, see above, report of the 3GPP TSG-T2 SWG3 MMS.

### EXAMPLE 5

### Conditional Recall

The sender of an MM_{A} wishes to recall it (two hours later). This is done using a new MM_{B} which is sent to the same recipient as the MM_{A} needing to be recalled. At this point, the header field X-Mms-Recall-ID with the appropriate Message-ID of the MM_{A} to be recalled is advantageously used in the WAP message M-send.req, see example 1. In addition, feedback about the Recall instruction issued is in this case requested using the header field X-Mms-Request-Report. The header field named X-Mms-Recall-Cond, newly defined on the basis of the present invention, is used in the WAP message M-Send.req. In this example, the field value is taken to be <Octet130>. This value corresponds to the sender's desire to effect the recall only if the MM_{A} has not been read, irrespective of whether a notification has been sent or whether the MM has already been downloaded.

X-Mms-Message-Type: m-send-req
X-Mms-Transaction-ID: 16
X-Mms-Version: 1.0
Date: Thu, 26 Oct 2000 14:12:19 +0100
From: abc@vas.de
To: xyz@siemens.de
X-Mms-Recall-ID: AAAA.1111@mms-relay01.siemens.de
X-Mms-Request-Report: Yes
X-Mms-Recall-Cond: Only before reading
Subject: recall of multimedia message a
Content-Type: text/plain

In this case, it will be assumed that the network element RSA establishes that it has forwarded the MM to be deleted to another network element RSB. In this case, receipt of the WAP message M-Send.req containing the Recall command in MM_{B} is acknowledged by the network element RSA using a WAP message M-Send.conf (see also FIG. 2). The latter message contains the Message-ID allocated by the network element RS for the MM_{B} (in this case: AAAA.2222@mms-relay01.siemens.de). In addition, the header field X-Mms-Supported-Feature contains the entry “Conditional Recall feature supported” newly defined in this inventive application.

M-Send.conf (network element RSA→MMS VAS application A):

X-Mms-Message-Type: m-send-conf
X-Mms-Transaction-ID: 16
X-Mms-Version: 1.0
X-Mms-Response-Status: ok
Message-ID: AAAA.2222@mms-relay01.siemens.de
X-Mms-Supported-Feature: conditional recall

In this case, it is assumed that the network element RSB establishes that the receiving application UAB has been notified and has retrieved the MM. Since the Recall condition may still be satisfied (MM should not yet have been opened/read), an attempt is still made to execute the Recall instruction. In this context, the receiving application UAB is informed, using the WAP message M-Notification.ind, that the MM_{A} previously downloaded needs to be recalled if it has not been read. This condition is also announced using the header field X-Mms-Recall-Cond with the field value <Octet130> (for Recall only before reading).

In this case, the message MM_{A} is also identified using the identification number. However, this identifier may be different from the Message-ID 1 (AAAA.1111@mms-relay01.siemens.de) on account of the forwarding to another network element RS, see above, WAP-209-MMSEncapsulation, Release 2000. In this exemplary embodiment, another Message-ID has therefore been chosen: BBBB.3333@mms-relay02.siemens.de.

In this example, the header field X-Mms-Content-Location refers to a URI whose memory location contains a standard text message from the service provider B (e.g.: “The sender wishes to recall the MM having the Message-ID BBBB.3333@mms-relay02.siemens.de.”). As such, receiving applications UAB which do not understand the new header fields of the Recall feature can also be subsequently informed about a Recall instruction sent by the sender.

M-Notification.ind (network element RSB→receiving application UAB):

X-Mms-Message-Type: m-notification-ind
X-Mms-Transaction-ID: 20
X-Mms-Version: 1.0
From: abc@vas.de
X-Mms-Message-Class: Personal
X-Mms-Message-Size: 42
X-Mms-Expiry: 3600
X-Mms-Content-Location: http://mms-
relay02.siemens.de/default-recall-message
X-Mms-Recall-ID: BBBB.3333@mms-relay02.siemens.de
X-Mms-Recall-Cond: Only before reading

The WAP message M-NotifyResp.ind is used to confirm correct receipt of the WAP message M-Notification.ind. If the MM_{A} has not been read, it can be deleted by virtue of the Conditional Recall command. In addition, the receiving application UAB reports the outcome of the Recall instruction in this case. This is done using the X-Mms-Status header field. In this example, this header field contains one of the entries newly defined in this inventive application, namely <Octet140> for “Recall successful, before MM has been read”.

M-NotifyResp.ind (receiving application UAB→network element RSB):

X-Mms-Message-Type: m-notifyresp-ind
X-Mms-Transaction-ID: 20
X-Mms-Version: 1.0
X-Mms-Status: Recall successful, before MM has been read

If the MM_{A} needing to be recalled has already been opened, no further attempt is made to delete it. Instead, the WAP message M-NotifyResp.ind contains the information about the failure of the Recall procedure because the MM_{A} has already been opened. The header field X-Mms-Status then has the value <Octet144> for “Recall failed, since MM has been read”. The M-NotifyResp.ind WAP message then has the following appearance:

M-NotifyResp.ind (receiving application UAB→network element RSB):

X-Mms-Message-Type: m-notifyresp-ind
X-Mms-Transaction-ID: 20
X-Mms-Version: 1.0
X-Mms-Status: Recall failed, since MM has been read

If the sender requires feedback for the Recall instruction which he has initiated, the network element RSA can use the WAP message M-Delivery.ind to send back feedback to the sending application UAA. The field “Message-ID” contains the ID of the Recall instruction (AAAA.2222@mms-relay01.siemens.de). For the status of the Recall, the extended header field X-Mms-Status, in which the (for example) successful deletion of the MM_{A} is confirmed using the field value “Recall successful, before MM has been read”, is likewise used in this case. Since the sending application UAA knows the relationship between the Message-ID of the Recall instruction and the Message-ID of the MM_{A} which should be recalled, the sender can be notified of whether or not his/her Recall instruction was able to be executed successfully (if the MMS service providers involved support this).

M-Delivery.ind (network element RSA→sending application UAA):

X-Mms-Message-Type: m-delivery-ind
X-Mms-Message-ID: AAAA.2222@mms-relay01.siemens.de
X-Mms-Version: 1.0
To: abc@vas.de
Date: Thu, 26 Oct 2000 14:14:09 +0100
X-Mms-Status: recall successful

### EXAMPLE 6

### Conditional Change or Replace

In this example, the sender wishes to update his/her MM_{A} (one hour after it has been sent): of the two elements originally sent, only the JPEG image (MIME content type “image/jpeg”) is now intended to be retained. In addition, the subject needs to be changed to “Agenda for our meeting”, see example 2. At this point, the header field X-Mms-Replace-ID with the appropriate Message-ID of the MM_{A} to be replaced is advantageously used in the WAP message M-Send.req. In addition, feedback about the Replace instruction issued is in this case requested using the X-Mms-Request-Report header field. The header field having the exemplary name X-Mms-Replace-Cond, newly defined in this inventive application, is used in the WAP message M-Send.req. In this example, the field value is taken as <Octet128>. This value corresponds to the sender's desire to effect the recall only if the recipient of the MM_{A} has not yet been notified about this message.

X-Mms-Message-Type: m-send-req
X-Mms-Transaction-ID: 32
X-Mms-Version: 1.0
Date: Thu, 26 Oct 2000 14:2:19 +0100
From: abc@vas.de
To: xyz@siemens.de
X-Mms-Recall-ID: AAAA.1111@mms-relay01.siemens.de
X-Mms-Request-Report: Yes
X-Mms-Recall-Cond: Only before notification
Subject: Agenda for our meeting
Content-Type: multipart/related: boundary=“-----
_=_NextPart_023_”
-----_=_NextPart_023_{—}
Content-Type: image/jpeg; name=“agenda.jpg”
Content-Transfer-Encoding: base64
Content-ID: <1725782>
...
-----_=_NextPart_023 _--

The text below consider s two cases:

Case 1: receiving application UAB has downloaded MM_{A} on account of a notification.

Case 2: the MM_{A} is still on the network element RSA, and no notification has been sent to the receiving application UAB.

Case 1:

Since the notification has already been sent, the condition for executing the Replace command is no longer satisfied. Consequently, replacement cannot and need not take place any longer. In this case, receipt of the WAP message M-Send.req containing the Replace command is acknowledged by the MMS Relay/Server using a WAP message M-Send.conf. This message contains the Message-ID allocated by the MMS Relay/Server for the MM_{B} (in this case: AAAA.2222@mms-relay01.siemens.de). In addition, the header field X-Mms-Supported-Feature contains the entry “Conditional Replace feature supported” newly defined in this inventive application. Since the Replace instruction cannot be executed, the instructioner is informed about the outcome of his instruction using the header field X-Mms-Response-Status: the field value <Octet152> announces that it has not been possible to execute the Conditional Replace operation, since the notification has already been sent:

“Replace failed, since notification has been sent”.

X-Mms-Message-Type: m-send-conf
X-Mms-Transaction-ID: 32
X-Mms-Version: 1.0
X-Mms-Response-Status: ok
Message-ID: AAAA.2222@mms-relay01.siemens.de
X-Mms-Supported-Feature: conditional replace
X-Mms-Status: replace failed, since notification was sent

If the network element RSA does not support Conditional Replace, it will treat the MM_{B} as a normal multimedia message and will therefore forward it to the recipient as usual with no regard to the MM_{A} which is to be replaced.

Case 2:

Since the notification has not yet been sent, the condition for executing the Replace command is satisfied. Replacement can therefore be effected as desired. The MM_{A} can be deleted on the network element RSA, and the sender is informed about this action using the header field X-Mms-Response-Status. The field value <Octet152> announces that the Conditional Replace operation has been effected before the notification was sent: “Replace successful, before notification”.

M-Send.conf (network element RSA→MMS VAS application A):

X-Mms-Message-Type: m-send-conf
X-Mms-Transaction-ID: 32
X-Mms-Version: 1.0
X-Mms-Response-Status: ok
Message-ID: AAAA.2222@mms-relay01.siemens.de
X-Mms-Supported-Feature: conditional replace
X-Mms-Status: replace successful, before notification

The new message MM_{B} then arrives at the receiving application UAB as a normal multimedia message announced by a separate notification. The recipient is thus informed that the sender has replaced the MM_{A} sent previously with a new MM_{B}.

Besides the methods described, the invention likewise covers the appropriate apparatuses, in particular telecommunication equipment and, in this context, mobile radios and the appropriate network elements. The present invention likewise covers the appropriate software programs.

Indeed, although the present invention has been described with reference to specific embodiments, those of skill in the art will recognize that changes may be made thereto without departing from the spirit and scope of the invention as set forth in the hereafter appended claims.

TABLE 1
Options for field value coding on the basis of WAP-203-WSP, Version
May 4, 2000; Wireless Application Protocol, Wireless Session Protocol
Specification; Chapter 8.4: “Header Encoding”.

| First octet of the | | |
|---|---|---|
| field value | Possible combinations | Number of subsequent octets |
| 0...30 | 31 | 0...30 |
| 31 | 1 | >30 |
| 32...127 (for text) | 96 | >0 |
| 128...255 | 128 | 0 |

Table 1: Options for field value coding on the basis of WAP-203-WSP, Version May 4, 2000; Wireless Application Protocol, Wireless Session Protocol Specification; Chapter 8.4: “Header Encoding”.

TABLE 2
Additional insertions in the WAP message M-Send.req.

| Name | Content | Comments |
|---|---|---|
| “X-Mms- | ID | Optional. This ID MUST always |
| Recall- | | be present if a sender wants to |
| ID” | | recall an MM sent previously. |
| | | Denotes the Message-ID of the |
| | | MM which a sender wants to |
| | | recall. |
| “X-Mms- | ID | Optional. This ID MUST always |
| Replace- | | be present if a sender wants |
| ID” | | to replace an MM sent previously. |
| | | Denotes the Message-ID of |
| | | the MM which a sender wants to |
| | | replace. |
| “X-Mms- | Yes \| No | Optional. Denotes whether the |
| Request- | | sender is requesting a report |
| Report” | | regarding whether or not a |
| | | Recall or Replace instruction |
| | | is successful. |
| “X-Mms- | Only before notification \| | Optional. Denotes the conditions |
| Recall- | Only before download \| | under which the Recall is |
| Cond” | Only before reading \| | abandoned. |
| | Even after reading | |
| “X-Mms- | Only before notification \| | Optional. Denotes the conditions |
| Replace- | Only before download \| | under which the Recall is |
| Cond | Only before reading \| | abandoned. |
| | Even after reading | |

TABLE 3
Additional insertions in the WAP message M-Send.conf.

| Name | Content | Comments |
|---|---|---|
| “X-Mms- | Recall \| Replace \| Not | Optional. |
| Supported- | supported \| Conditional | This field MUST always be |
| Feature” | Recall \| Conditional | present in instruction to |
| | Replace | indicate whether a service |
| | | provider is capable of |
| | | supporting one or more of the |
| | | service features. |
| “X-Mms- | Recall successful, before | Optional. |
| Status” | notification \| Recall failed, | This field indicates the status |
| | since notification already | of the Recall or Replace |
| | sent \| Replace successful, | operation. |
| | before notification \| | |
| | Replace failed, since | |
| | notification already sent | |

TABLE 4
Additional insertions in the WAP message M-Notification.ind.

| Name | Content | Comments |
|---|---|---|
| “X-Mms- | URI | Optional. Denotes a URI which is |
| Replaced-URI” | | no longer valid. |
| “X-Mms-Date-Of- | Date | Optional. |
| Execution” | | Denotes the date on which a Recall |
| | | or Replace instruction was executed. |
| “X-Mms- | ID | Optional. |
| Recall- | | ID MUST always be present if a |
| ID” | | sender wants to recall an MM sent |
| | | previously which has already been |
| | | delivered to the recipient. Denotes |
| | | the Message-ID of the MM which a |
| | | sender wishes to recall. |
| “X-Mms- | ID | Optional. |
| Replace- | | ID MUST always be present if a |
| ID” | | sender wishes to replace an MM sent |
| | | previously which has already been |
| | | delivered to the recipient. Denotes |
| | | the Message-ID of the MM which |
| | | the sender wishes to replace. |
| “X-Mms- | Only before | Optional. |
| Recall- | download \| | Indicates the conditions under which |
| Cond” | Only before | the Recall is abandoned. |
| | reading \| | |
| | Even after | |
| | reading | |
| “X-Mms- | Only before | Optional. |
| Replace- | download \| | Indicates the conditions under which |
| Cond | Only before | the Recall is abandoned. |
| | reading \| | |
| | Even after | |
| | reading | |

TABLE 5
Additional insertions in the WAP message M-NotifyResp.req.

| Name | Content | Comments |
|---|---|---|
| “X-Mms- | Rejected \| Downloaded \| | Imperative. |
| Status” | Deferred \| Recall | Message status. |
| | successful \| Recall failed \| | |
| | Replace successful, before | |
| | reading \| Replace failed, | |
| | since ... \| Recall service | |
| | feature supported \| | |
| | Replace service feature | |
| | supported | |

TABLE 6
Additional insertions in the WAP message M-Retrieve.conf.

| Name | Content | Comments |
|---|---|---|
| “X-Mms- | ID | Optional. |
| Replace-ID” | | The ID MUST always be present if a |
| | | sender wishes to replace an MM sent |
| | | previously. Denotes the Message- |
| | | ID of the MM which the sender |
| | | wishes to replace. |
| “X-Mms-Status” | Replace | Optional. |
| | successful | Indicates whether a message has |
| | | been replaced. |
| “X-Mms-Date-Of- | Date | Optional. |
| Execution” | | Indicates the date on which the |
| | | Recall or Replace operation was |
| | | executed. |
| “X-Mms-Replace- | Only before | Optional. |
| Cond” | reading \| | Indicates the conditions under which |
| | Even after | the Replace command is abandoned. |
| | reading | |

TABLE 7
Additional insertions in the WAP message M-Acknowledge.ind.

| Name | Content | Comments |
|---|---|---|
| “X-Mms- | Recall successful, before | Optional. |
| Status” | reading \| Recall failed, | This field indicates the status of |
| | since MM has been read \| | the message and of the Recall or |
| | Replace successful \| | Replace operation. |
| | Replace failed \| ... | |

TABLE 8
Additional insertions in the WAP message M-Delivery.ind.

| Name | Content | Comments |
|---|---|---|
| “X-Mms- | Recall successful, before | Imperative. Status of the |
| Status” | reading \| Recall failed, | message and of the operation. |
| | since MM has been read \| | |
| | Replace successful \| | |
| | Replace failed \| ... | |

1. A method for accessing a first MMS multimedia message, the first message being sent to a receiving application using a sending application, which may include a network VAS application, the method comprising the steps of:
defining a second MMS multimedia message which contains a manipulation instruction for manipulating the first message; and
enabling manipulative access to the first message, wherein the second message is at least one of created, sent, received, forwarded and processed in instruction.

2. A method for accessing a first message as claimed in claim 1, the message further comprising the step of sending both the first message and the second message via at least one of: radio, using mobile radio systems; inter-operator IP backbone; Internet e-mail; and over the Internet.

3. A method for accessing a first message as claimed in claim 1, the method further comprising the step of sending both the first message and the second message to the receiving application via at least one sender-end network element associated with a first service provider and at least one recipient-end network element associated with a second service provider.

4. A method for accessing a first message as claimed in claim 3, wherein the at least one sender-end network element and the at least one recipient-end network element belong to an area of competence of a single service provider.

5. A method for accessing a first message as claimed in claim 1, wherein the sending application and the receiving application are identical.

6. A method for accessing a first message as claimed in claim 1, wherein the manipulative access to the first message is effected on at least one of a sender-end network element, a recipient-end network element and the receiving application.

7. A method for accessing a first message as claimed in claim 1, wherein the manipulation instruction effects at least one of recall and deletion of the first message.

8. A method for accessing a first message as claimed in claim 4, wherein the manipulation instruction effects replacing the first message with the second message.

9. A method for accessing a first message as claimed in claim 8, wherein, if a Replace instruction is not supported by at least one of the service providers' MMS environments, the second message is delivered to the receiving application as a normal message, and the sender is informed of the delivery.

10. A method for accessing a first message as claimed in claim 8, wherein, given a Replace instruction, the second message is downloaded in one of a PUSH mode and a PULL mode.

11. A method for accessing a first message as claimed in claim 1, the method further comprising the step of sending the second message to a recipient of the first message, with the first message being identified via an identification number which clearly identifies the first message between the sending application and a sender-end network element.

12. A method for accessing a first message as claimed in claim 1, the method further comprising the step of providing a sender-end network element, via the sending application, when a message is sent, with at least one of: a flag indicating that the second message is a manipulation instruction; an identification number of the first message needing to be manipulated; and information that the sender is requesting feedback about an outcome of the initiated manipulation.

13. A method for accessing a first message as claimed in claim 1, the method further comprising the step of providing the sending application, via a sender-end network element, information regarding at least one of whether the network element supports manipulation of the first message, and whether the manipulation instruction has been accepted by a service provider associated with the sending application.

14. A method for accessing a first message as claimed in claim 1, the method further comprising the step of providing a recipient-end network element, via a sender-end network element, if the sending application and the receiving application belong to different MMS environments, with at least one of: a flag indicating that the second message is a manipulation instruction; an identification number of the first message needing to be manipulated; and information that the sender is requesting feedback about an outcome of the initiated manipulation.

15. A method for accessing a first message as claimed in claim 1, the method further comprising the step of executing, via network elements associated with different service providers, one-to-one, reversible conversion of identification numbers relating to at least one of the first message and the second message, and managing corresponding information.

16. A method for accessing a first message as claimed in claim 1, wherein, upon a manipulation instruction including a deletion command, when the receiving application has not yet been notified about the first message, the first message is deleted in one of an MMS environment of a sender-end service provider and in an area of competence of a recipient-end service provider, with the receiving application not be informed about the manipulation.

17. A method for accessing a first message as claimed in claim 1, wherein, upon a manipulation instruction when notification has been given at a reception end but the first message has not yet been downloaded, the first message is manipulated in an MMS environment of a reception-end service provider, with the receiving application being informed about the manipulation and a time of the manipulation.

18. A method for accessing a first message as claimed in claim 1, wherein, upon a manipulation instruction when notification has been given at a reception end but the first message has not yet been downloaded, the first message is manipulated in an MMS environment of a sender-end service provider, with the receiving application not be informed about the manipulation.

19. A method for accessing a first message as claimed in claim 1, the method further comprising the step of providing the receiving application in a notification, via a recipient-end network element, at least one of: information that the first message, which has been announced but not yet delivered, is no longer available for download and possibly has been replaced with the second message, at least one of the first message and the second message being identified using a URI; information that a sender which manipulate the first message which has already been delivered, the first message being identified on the receiving application using a message reference which is a URI whose memory location stores a standard text message from a recipient-end service provider, the URI including one of an identification number of the first message and a second identification number stipulated by a recipient-end network element; notification relating to manipulation of the first message by a service provider; notification relating to execution of a manipulation and, if requested by a recipient, relating to an unavailability of a manipulated message; a flag indicating that the second message contains a manipulation instruction needing to be carried out on the receiving application; information regarding which message already delivered needs to be manipulated; information regarding when a manipulation was carried out; information that a delivered second message is a subsequently replaced message; and information regarding a type of manipulation to be carried out.

20. A method for accessing a first message as claimed in claim 1, the method further comprising the step of providing a recipient-end network element, via the receiving application, upon the receiving application having been notified of the second message, with at least one of: information regarding whether the receiving application has understood that the first message, previously announced, has been successfully manipulated; information regarding whether the first message already downloaded was able to be manipulated successfully; information regarding at least one of whether a recipient has been informed about the already downloaded message having been manipulated, and whether the recipient has agreed to the already downloaded message having been manipulated; a reason for unsuccessful execution in the event of failure; information regarding whether, upon a Replace instruction, the already downloaded first message has been one of replaced automatically and replaced after prompting by the recipient; and information regarding a type of manipulation to be carried out.

21. A method for accessing a first message as claimed in claim 1, the method further comprising the step of providing a sender-end network element, via a recipient-end network element, if the sending application and the receiving application belong to different MMS environments of service providers, with at least one of: information regarding whether the manipulation instruction was able to be executed successfully; a reason for unsuccessful execution in the event of failure; information regarding when the manipulation instruction was executed; information regarding whether the manipulation instruction has been executed automatically; information regarding at least one of whether a recipient has been informed about the manipulation, whether the recipient has agreed to the manipulation, and whether the manipulation has been prompted by the recipient; information that the first message one of has been downloaded and manipulated, and has not yet been downloaded before a replacement; an interim identification number of the message which has been manipulated; and information regarding a type of manipulation executed.

22. A method for accessing a first message as claimed in claim 1, the method further comprising the step of providing the sending application, via a sender-end network element, with at least one of: information regarding whether the manipulation instruction has been executed successfully; a reason for unsuccessful execution in the event of failure; information that manipulation was not able to be executed due to the first message being forwarded to an unknown address; information regarding when the manipulation instruction was executed; information regarding whether the manipulation instruction has been executed automatically; information regarding whether the recipient at least one of has been informed about the manipulation, has agreed to the manipulation, and has initiated the manipulation; information that the first message already downloaded at least one of has been manipulated and has not yet been delivered before a replacement; and an identification number of the first message which has been manipulated.

23. A method for accessing a first message as claimed in claim 1, wherein the second message includes at least one information element which has been assigned by the sending application and contains at least one condition for executing the manipulative access.

24. A method for accessing a first message as claimed in claim 23, wherein the at least one information element indicates the manipulative access based on an editing status of the first message.

25. A method for accessing a first message as claimed in claim 23, the method further comprising the step of stipulating, by the sending application and using the at least one information element, at least one of: manipulation of the first message only if the first message is still on the server and a recipient has not yet been notified about the first message; manipulation of the first message even if notification has been sent, but the first message has not yet been downloaded; manipulation of the first message if the recipient has not yet opened the first message; and manipulation of the first message irrespective of a degree of editing.

26. A method for accessing a first message as claimed in claim 23, wherein the information element is assigned a default value representing a manipulation based on a default value if there is no condition stated in more precise terms.

27. A method for accessing a first message as claimed in claim 23, wherein at least one service provider involved in sending the first message and the second message limits the manipulation instruction to one of the service provider's own domains and certain domains of other service providers using one of an identification for a recipient and an additional flag.

28. A method for accessing a first message as claimed in claim 23, the method further comprising the step of assigning to the second message, containing the manipulation instruction, sent to a sender-end network element by the sending application, at least one of the following conditions for manipulating the first message: manipulation only before the recipient is notified; manipulation only before download, and after a notification has been sent; manipulation only if the first message has not yet been opened; and manipulation irrespective of an editing status of the first message.

29. A method for accessing a first message as claimed in claim 23, the method further comprising the step of notifying the sending application, via a sender-end network element, upon a confirmation after sending one of the first message and the second message, of whether the network element supports conditional manipulation and whether the conditional manipulation instruction has been accepted by the sender-end service provider.

30. A method for accessing a first message as claimed in claim 23, the method further comprising the step of transmitting to a recipient-end network element, via a sender-end network element, if the sending application and the receiving application belong to different MMS environments of service providers, at least one of the following conditions regarding manipulation of the first message by the second message: manipulation only before the recipient is notified; manipulation only before download, and after a notification has been sent; manipulation only if the first message has not yet been opened; and manipulation irrespective of an editing status of the first message.

31. A method for accessing a first message as claimed in claim 23, the method further comprising the step of transmitting to the receiving application, via a recipient-end network element, at least one of the following conditions regarding manipulation of the first message by the second message, upon notification about the second message having arrived: manipulation only before the recipient is notified; manipulation only before download, and after a notification has been sent; manipulation only if the first message has not yet been opened; and manipulation irrespective of an editing status of the first message.

32. A method for accessing a first message as claimed in claim 23, wherein the first message and the second message are sent, received and manipulated using WAP messages.

33. A method for accessing a first message as claimed in claim 23, wherein the manipulation instructions are implemented by at least one of modifying existing header fields and adding additional header fields in WAP messages based on a WAP-MMSEncapsulation Standard, the WAP messages including at least one of M-send.req, M-Send.conf, M-Notification.ind, M-NotifyResp.req, M-Retrieve.conf, M-Acknowledge.ind, and M-Delivery.ind.

34. A method for accessing a first message as claimed in claim 33, the method further comprising the step of identifying the first message for feedback about a result of the manipulation instruction using one of an identification number of the second message and transaction identification numbers of corresponding WAP messages, and an additional header field with field values for the new header field containing an identification number of the first message.

35. A telecommunication device for accessing a first MMS multimedia message, the first multimedia message being sent to a receiving application using the sending application, which may include a network VAS application, the telecommunication device comprising:
means for at least one of creating, sending, receiving and processing the first message; and
means for at least one of creating, sending, receiving and processing a second MMS multimedia message, the second message including a manipulation instruction for manipulating the previously sent first message.

36. A telecommunication device as claimed in claim 35, further comprising a transmission unit which is connectable to the sending application.

37. A telecommunication device as claimed in claim 35, further comprising a reception unit which is connectable to the receiving application.

38. A telecommunication device as claimed in claim 35, further comprising a processor unit for evaluating notifications from a sender-end network element regarding at least one of support of the manipulation instruction, successful execution of the manipulation instruction, and reasons for unsuccessful execution of the manipulation instruction.

39. A telecommunication device as claimed in claim 35, further comprising a processor unit for evaluating notifications from a recipient-end network element about information regarding execution of the manipulation instruction.

40. A telecommunication device as claimed in claim 39, wherein the transmission unit sends notifications to a recipient-end network element regarding at least one of successful execution of the manipulation instruction and reasons for unsuccessful execution of the manipulation instruction.

41. A telecommunication device as claimed in claim 35, wherein the telecommunication device is a mobile telephone having a transmission unit and a reception unit.

42. A telecommunication device as claimed in claim 35, wherein the telecommunication device is a network element holding a VAS application.

43. A telecommunication device as claimed in claim 35, wherein the telecommunication device processes WAP messages based on a WAP-MMSEncapsulation Standard, the WAP messages including at least one of M-Send.req, M-Send.conf, M-Notification.ind, M-NotifyResp.req, M-Retrieve.conf, M-Acknowledge.ind, and M-Delivery.ind, wherein the manipulation instructions are implemented by at least one of modifying existing header fields and adding additional header fields.

44. A telecommunication device as claimed in claim 35, further comprising:
means for producing an information element; and
means for assigning the information element to the second message by the sending application, the information element containing at least one condition for executing the manipulative access.

45. A telecommunication device as claimed in claim 44, further comprising means for executing the manipulative instruction.

46. A network element in a radio communication system for network execution of a method for accessing a first MMS multimedia message, the first message being sent to a receiving application using a sending application, which may include a network VAS application, the network element comprising:
means for receiving and forwarding the first message sent by a telecommunication device; and
means for at least one of receiving, processing and forwarding a second MMS multimedia message containing a manipulation instruction relating to the first message to enable manipulative access to the first message.

47. A network element as claimed in claim 46, further comprising means for at least one of receiving and forwarding, and producing and sending, notifications to at least one of another network element, the sending application and the receiving application, the notifications relating to at least one of a sender's stipulated conditions for executing the manipulation instruction specified in the second message, successful execution of the manipulation instruction, and reasons for unsuccessful execution of the manipulation instruction.

48. A network element as claimed in claim 46, further comprising means for executing the manipulation instruction.

49. A network element as claimed in claim 48, wherein the first message can be manipulated on at least one of a network element and a receiving application in a reception unit.

50. A network element as claimed in claim 46, wherein the means for receiving, processing and forwarding the second message uses WAP messages based on a WAP-MMSEncapsulation Standard, the WAP messages including at least one of M-Send.req, M-Send.conf, M-Notification.ind, M-NotifyResp.req, M-Retrieve.conf, M-Acknowledge.ind, and M-Delivery.ind, wherein the manipulation instructions are implemented by at least one of modifying existing header fields and adding additional header fields.

51. A software program capable of running on a telecommunication device having a processor, wherein execution of the software program effects a method for accessing a first MMS multimedia message, the first message being sent to a receiving application using a sending application, which may include a network VAS application, the method comprising the steps of:
defining a second MMS multimedia message which contains a manipulation instruction for manipulating the first message; and
enabling manipulative access to the first message, wherein the second message is at least one of created, sent, received, forwarded and processed in instruction.
